(19) United States
(12) Patent Application Publication
(10) Pub. No.: US 2013/0174868 A1
(43) Pub. Date: Jul. 11, 2013

(54) METHOD FOR PURIFYING ALKALINE TREATMENT FLUID FOR SEMICONDUCTOR SUBSTRATE AND A PURIFICATION APPARATUS

(71) Applicants: Hisashi Muraoka, Yokohama-shi (JP); Toshitsura Cho, Kawasaki City (JP)

(72) Inventors: Hisashi Muraoka, Yokohama-shi (JP); Toshitsura Cho, Kawasaki City (JP)

(73) Assignees: UMS CO., LTD., Yokohama-shi, Kanagawa (JP); TAMA CHEMICALS CO., LTD., Kawasaki City, Kanagawa (JP)

(21) Appl. No.: 13/824,946

(22) PCT Filed: Sep. 26, 2011
(86) PCT No.: PCT/JP2011/071928

§ 371 Date: Mar. 26, 2013

(30) Foreign Application Priority Data
Sep. 27, 2010 (JP) 2010-230962

(51) Int. Cl. B01J 20/10

(52) U.S. Cl. CPC B01J 20/10
USPC 134/3; 210/263; 210/660

(57) ABSTRACT

Provided are a purification method and purification apparatus for an alkaline treatment liquid for a semiconductor substrate, which use adsorption purification means that can purify various alkaline treatment liquids to be used for treating semiconductor substrates for various purposes so as to have an ultrahigh purity, in particular, an Fe concentration in a ppq region, and that is excellent in chemical resistance and mechanical strength. The adsorption purification means is purification means for an alkaline treatment liquid for treating a semiconductor substrate for various purposes at the time of producing, for example, a semiconductor substrate or a semiconductor device. In the purification method and purification apparatus for an alkaline treatment liquid for a semiconductor substrate, an alkaline treatment liquid is brought into contact with silicon carbide crystal surfaces in the absorption purification means, for example, an alkaline treatment liquid is allowed to flow through a gap between adsorbing plate laminates (2) whose both surfaces are CVD silicon carbide surfaces, thereby removing metal impurities contained in the alkaline treatment liquid through adsorption of the metal impurities to the silicon carbide crystal surfaces.

### TECHNICAL FIELD

The present invention relates to a method for purifying an alkaline treatment liquid which is used for treating a semiconductor substrate for various purposes and a purification apparatus, for example, when the semiconductor substrate is produced or when a semiconductor device or the like is produced by using the semiconductor substrate, and more specifically, to a method for purifying an alkaline treatment liquid for a semiconductor substrate, by which concentrations of metal impurities, in particular, iron (Fe), which are contained in very small amounts in various alkaline treatment liquids to be used for treating the semiconductor substrate, contaminate a surface of the semiconductor substrate, and are harmful to a device or the like to be produced by using the semiconductor substrate, can be reduced to a ppq (one thousandth of ppt) region, if necessary, and to a purification apparatus used for carrying out the above-mentioned purification method.

### BACKGROUND ART

Hitherto, as a typical alkaline treatment liquid to be used for treating a semiconductor substrate such as a silicon wafer (Si wafer) at the time of producing a semiconductor device, for example, there has been used a hydrogen peroxide-containing ammonia aqueous solution (such as SC1 supplied by RCA), which is the most powerful cleaning agent against particles contaminating the Si wafer, or an organic strong base aqueous solution used for developing a positive resist film. Further, as the organic strong base contained in the organic strong base aqueous solution, a tetraalkylammonium hydroxide has been typically used, and tetramethylammonium hydroxide (TMAH) has been generally used. However, when a commercially available product thereof was initially produced, the product contained metal impurities such as Na, Fe, Zn, Ca, Mg, Ni, Cr, Al, and Cu at concentrations of about several ppm and contained K as a metal impurity at a much higher concentration, and hence the metal impurities caused problems such as deterioration of electric characteristics of a device and pattern defects.

A TMAH aqueous solution was initially produced by a method in which an alcohol solution of tetramethylammonium chloride is caused to react with hydroxides, the resultant precipitates are removed by filtration, and the alcohol solvent is then removed (see, for example, Patent Literature 1), and hence the TMAH aqueous solution was liable to be contaminated with metals owing to dissolution of metal impurities such as Fe, Al, Ni, and Na from its production materials, production apparatus, storage containers, and the like. Thus, in order to remove these metal impurities contained in the TMAH aqueous solution, it was proposed to use an ion exchange resin such as a polyacrylic gel-based weakly acidic ion exchange resin (see Patent Literature 2), and hence it became possible to purify a 5-wt % TMAH aqueous solution to an Fe concentration of 10 ppb. However, even in the TMAH aqueous solution thus purified, highly corrosive chlorides remained, and hence it was difficult to prevent completely contamination derived from a storage container. In particular, Fe was a heavy metal which was detected as the most significant contaminant on treatment surfaces treated by using an organic alkaline treatment liquid of this kind at that time.

Thus, there was proposed an ultrahigh purification method in which a TMAH aqueous solution was produced by electrolyzing a quaternary ammonium inorganic acid salt such as tetramethylammonium carbonate in an electrolytic bath in which a cation exchange membrane is used as a diaphragm, thereby preventing as completely as possible contamination with impurities such as metal elements and halogen elements (see Patent Literature 3). As a result, a 10-wt % TMAH aqueous solution having such a low level of contamination as an Fe concentration of 5 ppb was provided. After that, various related materials were highly purified and production environment was cleaned, and consequently, in the cases where a 25-wt % TMAH aqueous solution prepared by using any of disclosed stock solutions was used to analyze metal impurities, 1 ppb or less was achieved as the concentration of each of all metal elements, and in particular, in the case where a 25-wt % TMAH aqueous solution highly purified for an analysis purpose was used to analyze Fe, it was revealed that the concentration of Fe was 0.1 ppb, which was the measurement limit value, or less (see Non Patent Literature 1). However, in an about 2.4-wt % TMAH developer supplied to production sites, Fe as an impurity exists at a concentration of around 100 ppt.

Further, as another organic strong base aqueous solutions in practical use as a developer for producing a semiconductor device, there is known an aqueous solution of trimethylhydroxyethylammonium hydroxide (choline) (choline aqueous solution). The choline aqueous solution is produced by a production method in which a trimethylamine aqueous solution and an ethylene oxide aqueous solution serving as materials are mixed and caused to react by particular means, thereby causing by-products in trace amounts to coexist at particular concentrations (see Patent Literature 4), yielding a developer which is capable of controlling the speed of development. Contamination control can be easily performed from material to production, thus being able to produce easily a highly purified developer. In the case where a 5-wt % choline aqueous solution disclosed was used to analyze metal impurities, it was revealed that the concentration of Fe was 0.3 ppb, which was the measurement limit value measured by normal analytical means, or less (see Non Patent Literature 1). In the 5-wt % choline aqueous solution, Fe as an impurity usually exits at a concentration of around 100 ppt.

When cleaning treatment of a normal Si wafer is carried out by using the above-mentioned cleaning agent SC1, elements which are metals contained in the cleaning liquid at concentrations of 1 ppb and contaminate a surface of the Si wafer at concentrations of 1×10¹¹atoms/cm² or more after the cleaning treatment are at most Al, Fe, and Zn. Among these elements, Fe is a heavy metal that causes problems such as an increase in junction current of a device, life time deterioration, and poor pressure resistance of an oxide film. Further, ammonia water (29 wt %) and an hydrogen peroxide solution (30 wt %), which are chemicals for a semiconductor used at the time of preparing the cleaning agent SC1, can also be purified relatively easily to an ultrahigh extent by means such as distillation. However, the production apparatus and transporting vessel therefor involve drawbacks in their materials as in the case of the above-mentioned organic strong base, and Fe may probably exist at a concentration of about 0.03 to 0.1 ppb in these chemicals for a semiconductor as well, though the standard of the Fe concentration in both commercially available chemicals has been set, over these several years, to 0.1 ppb, which is the measurement limit value measured by normal analytical means, or less.

Thus, when the composition of the cleaning agent SC1 prepared by using such chemicals for a semiconductor is, for example, 1 volume of 29-wt % ammonia water for a semiconductor, 1 volume of a 30-wt % hydrogen peroxide solution, and 10 volumes of ultrapure water, the Fe concentration in the cleaning agent SC1 is about a little less than 10 ppt. Hitherto, the inventors of the present invention have used an SC1 liquid prepared by using chemicals for a semiconductor with the highest purity available (including organic impurities), have added Fe to the SC1 liquid to prepare SC1 liquids having various Fe concentrations, have dipped Si wafers in these SC1 liquids, and have calculated a relationship between the Fe concentration in the SC1 liquid and the adsorption concentration of Fe adsorbed to the surfaces of each Si wafer dipped in the SC1 liquid in an equilibrium state. As a result, the inventors have obtained, as shown with a thick solid line in FIG. 5, a Cv-Cs double logarithmic relationship diagram showing “a relationship between an RI-labeled Fe concentration in the SC1 liquid (Cv: atoms/cm³) and an RI-labeled Fe adsorption concentration on the surface of the Si wafer (Cs: atoms/cm²)” (Non Patent Literature 2). In Non Patent Literature 2, a Freundlich adsorption straight line was obtained in the region of Cv concentrations of 0.1 to 10 ppb in FIG. 5, and hence the region of 0.1 to 1 ppb was cited, but it has been found from the results of subsequent experiments described later that the Freundlich rule is also true in a region having Cv concentrations lower than 0.1 ppb and the slope of each straight line is about 45°. Then, as understood from the fact that the Freundlich adsorption straight line (thick solid line) of the SC1 liquid is extended downward to draw a thick dotted line as shown in FIG. 5, it has been found that the Fe concentration in the SC1 liquid needs to be 1 ppt or less in order to suppress the Fe contamination from the SC1 liquid to the cleaning surface of an Si wafer at 1×10⁹ atoms/cm² or less in the cleaning of the Si wafer with SC1.

Further, a choline hydrogen peroxide aqueous solution (hereinafter referred to as “choline cleaning liquid”) is given as a cleaning liquid that provides a similar cleaning effect under the same treatment condition as the SC1. The choline cleaning liquid contains choline at 0.1 wt %, hydrogen peroxide at 4 wt %, and water at 95.9 wt % as its normal composition (The choline cleaning liquid having this composition is hereinafter particularly abbreviated as “COPO.”). COPO has such preferred characteristics that ammonia contamination, which is harmful to an environmental atmosphere in the production of a semiconductor device, is not caused and the cleaning surface is hardly contaminated by the environmental atmosphere.

Further, the inventors of the present invention have made an experiment on the adsorption of Fe existing in the COPO to silicon surfaces as in the case of the SC1 in FIG. 5, and have obtained a Freundlich adsorption straight line which is substantially parallel to that of the SC1 and is located slightly below that of the SC1 in the region of Fe concentrations of 0.1 to 1 ppb (in which a very small amount of a chelating agent added to the liquid is probably involved). It has recently become possible to purify the COPO so as to have an Fe concentration of nearly 100 ppq. Then, the inventors have purified the COPO so as to have an Fe concentration of 100 ppq or less, have added radioactive Fe at 1 ppb or less to the resultant COPO, and have made verification by carrying out an RI tracer experiment (hereinafter referred to as “RI tracer method”) by a radioluminography (RLG) method. As a result, the inventors have found that this Freundlich adsorption straight line can be extended to this ppq region (see Non Patent Literature 3).

The method which was adopted in the experiment in Non Patent Literature 3 in order to purify the COPO so as to have an Fe concentration in the ppq region was a method that the inventors of the present invention had already put into practice. This method is performed by using a purification method in which filtration is preformed through a silicon grain-packed layer that is packed with silicon grains made of the same material as that for a wafer which is an object to be cleaned (Patent Literature 5), and the effect of the method was confirmed in advance by the RI tracer method. Although the purification method in which filtration is preformed through a silicon grain-packed layer had been used for about ten years to remove Cu and Au in hydrofluoric acid in semiconductor plants, the use of the method was stopped because the influence of fluorosilicic acid that dissolved caused some problems. Further, there is known a case in which the purification method is applied to SC1 for purifying the SC1 so as to have an Fe concentration of about 1 ppt by causing Fe to adsorb to silicon, and the resultant SC1 is used for cleaning (Patent Literature 6), but an adsorbent in this case may have any one of a plate shape, a grain shape, and a block shape, and it seems that the surfaces of the silicon need to be preliminarily treated with fluorosilicic acid so as to have an impurity concentration of 10⁹/cm² or less.

By the way, the SC1 liquid has an etching action to a silicon surface at about 0.5 nm/minute or more under a normal treatment temperature of 70° C. In a silicon grain-packed layer, there are usually used silicon grains having grain sizes that a ratio S/V of the total surface area of the grains to the volume of a liquid to be purified which fills the gaps between the grains is about 100. If the Fe concentration of the entire grains is assumed to be 0.1 ppm uniformly, Fe is dissolved at 0.1 ppb when the grains are brought into contact with a liquid for one minute. Thus, adsorption purification cannot be performed to a level equal to or lower than 0.1 ppb. It is possible to produce silicon grains having an Fe concentration of 0.1 ppm or less by a CVD fluid bed method, but the method has a disadvantage from the economical point of view. In addition, when silicon fine grains are produced by pulverizing a silicon ingot for a semiconductor, Fe contamination derived from a pulverizer occurs, and because it is difficult to remove the Fe contamination by cleaning or the like, even an Fe concentration of 0.1 ppm cannot be obtained by this method. The silicon grains involve problems in their purity as described above. In addition to that, when the silicon grains are used for the purification treatment of SC1, silicon dissolves into the SC1, yielding metasilicate ions (SiO₃²⁻) at a ratio of as high as 0.5 mM/L per minute. The metasilicate ions possibly have an unfavorable influence (such as producing microparticles to, for example, a metal hydroxide colloid which is dispersed in the SC1 liquid and is positively charged.

### CITATION LIST

### Patent Literature

[PTL 1] JP 52-3008 A

[PTL 2] JP 57-139042 A

[PTL 3] JP 07-88593 B

[PTL 4] JP 63-2427 B

[PTL 5] JP 46-031935 B

[PTL 6] JP 2893493 B2

### Non Patent Literature

[NPL 1] “Tama Chemicals Co., Ltd., Product Brochure 2004,” Tama Chemicals Co., Ltd., May 2004

[NPL 2] “J. Electrochem. Soc., Vol . 141, No. 10, ” Electrochem. Soc., year 1994, p. L 139

[NPL 3] “Proceedings of The 47th Annual Meeting on Radioisotope and Radiation Research,” Japan Radioisotope Association, year 2010, p. 76

### SUMMARY of INVENTION

### Technical Problem

It is iron (Fe) which is said to be the most harmful metal impurity among metal impurities in an alkaline treatment liquid. Although iron (Fe) has an Fe(OH)₃ solubility product of as very small as 1×10⁻³⁸, most iron atoms are usually dispersed as a ferric hydroxide colloid in which Fe oxide hydrates are condensed, in a low concentration region as long as easily soluble iron complex ions are not formed. However, when the concentration of Fe reduces to nearly 10 ppt or less, the ferric hydroxide colloid acts as a positive colloid more strongly as described below, Fe is liable to adsorb to an oxide film, which has a slightly higher negative zeta potential than a silicon surface (that is, Fe contamination increases), and hence a device is adversely affected. A first countermeasure against this problem is to reduce preliminarily the amount of Fe sufficiently in the alkaline treatment liquid, and consequently, the resultant alkaline treatment liquid can meet a demand for cleaning from the viewpoint of electric characteristics. Further, when cleaning treatment of an Si wafer is performed by using SC1, even if the Si wafer can be cleaned to the level of an Fe adsorption concentration of 1×10⁸/cm² in consideration of an apparatus for the cleaning treatment and an environment thereof, it is necessary to purify the SC1 liquid so as to have an Fe concentration of 50 ppq or less prior to the cleaning treatment, as estimated on the basis of the thick dotted line drawn by extending downward the thick straight line in the Cv-Cs double logarithmic relationship diagram shown in FIG. 5.

Thus, an object of the present invention is to provide purification means for an alkaline treatment liquid for a semiconductor substrate by which a high-purity alkaline treatment liquid that is produced by using commercially available high-purity chemicals in order to treat a semiconductor substrate for various purposes is further purified, thereby being able to reduce the concentration of Fe in the alkaline cleaning liquid to a value in the ppq region.

Further, when adsorption purification is applied to an alkaline treatment liquid in a silicon grain-packed bed just before using the alkaline treatment liquid, the purification is applicable. However, as described above, a silicon surface is liable to undergo etching, the purity of silicon grains is far lower than that of a silicon single crystal or the like, and hence metal impurities such as Fe contaminate the alkaline treatment liquid, preventing the higher purification thereof, and metasilicate ions dissolve and contaminate the alkaline treatment liquid to the extent that the alkaline treatment liquid cannot be categorized as a high-purity liquid. Silicon fine grains are worn away by this etching earlier than expected and may be turned into harmful microparticles when the etching is performed.

Thus, another object of the present invention is to provide purification means for an alkaline treatment liquid for a semiconductor substrate, which has high etching resistance (that is, strong chemical resistance) and strong mechanical strength and by which a ferric hydroxide colloid or the like in the alkaline treatment liquid for a semiconductor substrate is strongly adsorbed, thereby being able to purify the alkaline treatment liquid so as to have very high purity.

Further, in order to carry out the cleaning treatment of huge numbers of semiconductor substrates or the like promptly and accurately, in semiconductor device production plants, for example, a predetermined sequence of multi-tank dipping automatic cleaning treatment for semiconductors is generally performed. Particularly when SC1 cleaning treatment, which is the most powerful method to remove particles, is performed, the circulation filtering regenerative mechanism for an SC1 liquid is widely used to enhance the effect of the SC1 cleaning treatment additionally. However, when circulation of the SC1 liquid is performed, an object to be cleaned is cleaned, releasing impurities, and the impurities accumulate in the liquid, particularly deteriorating the purity of Fe. Using SC1 is preferred to remove particles, but SC1 is rarely used at the sequence final stage.

Thus, still another object of the present invention is to provide, in order to enable, for example, liquid circulation type alkaline hydrogen peroxide cleaning, which is able to retain the remaining amount of Fe on a surface of a cleaned wafer at 10⁸ atoms/cm² order at the final stage of multi-tank dipping cleaning in the production process of a semiconductor device, a purification method and apparatus which are effective for particularly removing Fe when being inserted in the liquid circulation system and enable the regeneration of the liquid.

### Solution to Problem

That is, according to the present invention, there is provided a method for purifying an alkaline treatment liquid for a semiconductor substrate to be used for treating a semiconductor substrate, including: bringing the alkaline treatment liquid into contact with silicon carbide crystal faces in adsorption purification means; and removing metal impurities contained in the alkaline treatment liquid through adsorption of the metal impurities to the silicon carbide crystal faces.

According to the present invention, there is also provided a purification apparatus for an alkaline treatment liquid for a semiconductor substrate, which is used for purifying an alkaline treatment liquid to be used for treating a semiconductor substrate, thereby removing metal impurities in the alkaline treatment liquid, the apparatus including adsorption purification means that has silicon carbide crystal faces with which the alkaline treatment liquid is brought into contact, and that is configured to remove metal impurities contained in the alkaline treatment liquid through adsorption of the metal impurities to the silicon carbide crystal faces.

In the present invention, examples of the alkaline treatment liquid to be subjected to purification treatment include the following liquids that are used when semiconductor substrates such as a silicon wafer and a silicon carbide wafer are treated for various purposes when these semiconductor substrates are produced or when semiconductor devices and the like are produced by using these semiconductor substrates. That is, among alkaline treatment liquids used at the time of producing semiconductor substrates, an alkaline treatment liquid which is required to have particularly high purity is a SC1 cleaning liquid, which is used in a polishing step, epitaxial pre-cleaning, or the like. An inorganic strong base aqueous solution which is used in a double surface lapping step or the like preferably has high purity as well in regard to heavy metals. Examples of the alkaline treatment liquid used for treatment of substrates at the time of producing semiconductor devices include an alkaline hydrogen peroxide aqueous solution, which is mainly typified by SC1, which is a typical cleaning liquid used in cleaning steps each belonging to many steps such as an oxidation step, a diffusion step, and a CVD step, and is also typified by a choline aqueous solution. In addition, as a special cleaning liquid used in a high voltage power device diffusion step, there is also given an inorganic/organic strong base aqueous solution containing a surfactant.

Further, among the alkaline treatment liquids to be subjected to purification, as an alkaline treatment liquid used particularly frequently, there is first given an organic strong base aqueous solution for a positive resist developer, which is used in a positive resist film development step at the time of producing a semiconductor device. Specific examples thereof include an aqueous solution of a tetraalkylammonium hydroxide typified by TMAH and an aqueous solution of a trimethylhydroxyalkylammonium hydroxide typified by choline. Further, the objects to be subjected to the purification of the present invention include a strongly basic aqueous solution used for anisotropic wet etching applied to an Si wafer for VMOS or the like and a weakly basic aqueous solution such as ethylenediamine. In addition, examples of the alkaline treatment liquids which are objects to be subjected to the purification of the present invention, are used in a cleaning step, etc. at the time of producing a semiconductor substrate, a semiconductor device, or the like, and are desired to be highly purified to a level as low as possible in the ppq region particularly in regard to the concentration of Fe include a cleaning liquid (SC1), which is prepared by using a high-purity hydrogen peroxide solution which has such high purity as being suitable for a semiconductor and from which even organic impurities for preventing decomposition particularly having a chelating action are removed, and high-purity ammonia water having a cleanness equal to or higher than that suitable for a semiconductor. Further, another example is a liquid which is used in almost the same step as SC1 for reasons in regard to production environment and is formed of a high-purity hydrogen peroxide solution which has such high purity as being suitable for a semiconductor and from which even organic impurities for preventing decomposition particularly having a chelating action are removed, and an organic strong base aqueous solution. Note that, when an Si single crystal wafer is used to produce a solar cell, a micropyramid-like texture is always formed to reduce the surface reflectance of the wafer, and an inorganic strong base aqueous solution such as a KOH (about 5%) aqueous solution used for etching the texture can be an object to be subjected to the purification of the present invention. When a treatment liquid provided with a countermeasure for iron contamination is used at the time of forming a p-n junction, the lifetime of the resultant device may decrease.

Further, the purification method of the present invention is used for further purifying an alkaline treatment liquid having high purity that is usually available in the market for producing semiconductors in semiconductor plants, thereby particularly reducing the concentration of Fe to a value in the ppq region. It is preferred to use, as an alkaline treatment liquid which is an object to be subjected to purification, a high-purity alkaline treatment liquid which is usually available in the market, has the highest purity, has a low concentration of metal impurities, and particularly has an Fe concentration of 3 to 10 ppt. Further, it is possible, if necessary, that an alkaline treatment liquid supplied from the market is preliminarily purified by another known purification method, yielding a liquid having a reduced Fe concentration in the above-mentioned range, and then the purification method of the present invention is applied to the liquid.

Further, in the present invention, the silicon carbide crystal face with which such alkaline treatment liquid is brought into contact is not particularly limited. A crystal face of a silicon carbide single crystal may be adopted or a crystal face of a silicon carbide polycrystal formed by a chemical vapor deposition (CVD) method may be adopted. The latter has a smaller difference in adsorption performance between its front surface and back surface when used as a substrate.

In order to describe metal impurities that can be purified by the purification method and purification apparatus of the present invention, Fe, which is a heavy metal substantially most harmful to an Si wafer in the above-mentioned production process of a semiconductor device, was used as an object to be described. However, the present invention is effective not only to the impurity Fe but also to other metal impurities which form metal hydroxide colloids each having a positive charge in an alkaline treatment liquid. Example of the metal impurities which form metal hydroxide colloids each having a positive charge in an alkaline treatment liquid include Ca and Zn, which exist in a stock solution of an organic strong base aqueous solution having a high concentration and cause the poor pressure resistance of an oxide film and Vₜₕ shift, and Al, which exists in an alkaline hydrogen peroxide cleaning liquid and increases an interface state. In the following descriptions as well, purification for removing the impurity Fe is mainly described, but the description about the purification for removing the impurity Fe is also applicable to these metals.

### Advantageous Effects of Invention

The most significant technical feature of the present invention resides in the use of the silicon carbide crystal face having an extremely strong adsorption purification ability to metal hydroxide colloid impurities each having a positive charge in an alkaline treatment liquid as the adsorption purification means at the time of removing metal impurities in the alkaline treatment liquid. The silicon carbide crystal face presented by the present invention has far stronger adsorption performance than the (100) face having high adsorption performance in a silicon crystal. For example, according to the measurement results of the adsorption concentrations of a silicon (100) crystal face (A) and a silicon carbide (0001) crystal face (B) shown in FIG. 7, the measurement results being obtained from radioluminography images (RLG images) provided by an RI tracer method tracing a ⁵⁹Fe hydroxide colloid, the silicon carbide (0001) crystal face (B) shows 4,675 PSL/mm² and the silicon (100) crystal face (A) shows 1,214 PSL/mm². Thus, it is judged that the silicon carbide (0001) crystal face has an adsorption ability about four times as high as that of the silicon (100) crystal face. Further, among CVD polycrystal silicon carbide substrates, some substrates show ⁵⁹Fe adsorption nearly two times as high as that of the single crystal substrate when the total ⁵⁹Fe adsorption of both top and back surfaces is compared between the polycrystal and single crystal substrates.

Thus, in the present invention, the silicon carbide crystal face is used as the adsorption purification means for metal impurities in an alkaline treatment liquid, and the silicon carbide crystal face provides an obviously higher purification effect than silicon. Moreover, silicon carbide does not substantially dissolve into an alkaline treatment liquid unlike silicon, and hence silicon carbide provides such an effect that, even if the silicon carbide crystal per se which is used as the adsorption purification means contains trace amounts of metal impurities, the metal impurities only contaminate the alkaline treatment liquid to a negligible extent. Further, the essential reduction of the purity of the alkaline treatment liquid due to contamination by production of metasilicate ions in the alkaline treatment liquid occurs to a negligible extent as well. Silicon carbide has a hardness next to diamond, in addition to the effects of chemical resistance as described above, and hence the phenomenon of mechanical degradation such as production of particles hardly occurs. Thus, the effects of the present invention are outstanding from the viewpoints of preservation and economy.

According to the present invention, metal impurities which adsorb to the silicon carbide crystal face from an alkaline treatment liquid are easily removed from the silicon carbide crystal face by cleaning treatment with an extremely weak acid-based cleaning agent and water rinse, and hence the silicon carbide crystal face used as the adsorption purification means can be easily regenerated. A large effect of the present invention resides in that it is possible to easily construct a multistep parallel silicon carbide adsorption purification mechanism in which both the adsorption purification means having silicon carbide crystal faces and regeneration means for regenerating the silicon carbide crystal faces are incorporated. Further, silicon carbide has excellent chemical resistance and excellent mechanical strength and can be used to prepare easily a grainy adsorbent, and hence silicon carbide exerts such an effect that an alkaline treatment liquid can be purified easily and stably by passing the liquid through an adsorbent-packed column which is packed with the adsorbent. Fine particles of silicon carbide do not necessarily have a crystal face having the most preferred adsorption characteristics as a surface, and it is estimated that some fine particles of silicon carbide may exert a low purification ability as the adsorption purification means. However, the ratio of the total surface area (S) of the grainy adsorbent in the adsorbent-packed column to the volume (V) of a filling liquid (alkaline treatment liquid) to be brought into contact with the grainy adsorbent, that is, S/V, is large, and hence a substantially enough removal ratio as an adsorbent-packed column can be achieved. When the purification of the present invention is carried out as multistage purification by using a mechanism constructed as describe above, in general, the purification brings about such an effect that the concentration of Fe in an alkaline treatment liquid can be reduced to a value in a lower region by about two orders of ppq. When the final stage of a sequence of a multi-tank dipping automatic cleaning apparatus is performed by alkaline hydrogen peroxide cleaning provided with the mechanism, preceded by treatment with a hydrofluoric acid-containing cleaning liquid, the concentration of Fe remaining on a surface of a cleaned wafer can be reduced to 1×10⁸ atoms/cm² order.

According to the present invention, it is possible to remove effectively Fe, which is a typical harmful metal element and remains in a high-purity product of a strongly alkaline treatment liquid such as an organic strong base aqueous solution, for example, a developer for positive resist development used at the time of producing a semiconductor device, at a site where the high-purity product is used and just before the high-purity product is used. Thus, ultrahigh purification treatment of a developer or the like can be easily carried out and controlled, and when a chemical manufacturer stores an undiluted, highly-concentrated, ultrahigh-purity product or put it in a transport container, contamination of the product can be controlled more easily.

### BRIEF DESCRIPTION OF DRAWINGS

FIG. 1 are conceptual explanatory diagrams for illustrating an adsorbing plate laminate (adsorption purification means) used in a purification method for an alkaline treatment liquid of the present invention.

FIG. 2 is a conceptual explanatory diagram for illustrating purification of an alkaline treatment liquid using the adsorbing plate laminate of FIG. 1 and regeneration treatment of the adsorbing plate laminate after being used for the purification.

FIG. 3 is a conceptual explanatory diagram for illustrating a cleaning apparatus for cleaning an alkaline treatment liquid used in a tank at the final stage in a multi-tank dipping cleaning system by circulating the alkaline treatment liquid via an adsorbent-packed column (adsorption purification means) in which a grainy adsorbent having a silicon carbide crystal face are packed, the adsorbent-packed column being adopted as the purification method of the present invention, the cleaning apparatus being additionally provided with a regeneration treatment mechanism for solving reduction of the ability of the adsorbent.

FIG. 4 is a sectional conceptual diagram of an adsorption column in which an adsorbing plate laminate formed of many adsorbing plates having a thin plate shape and including a polycrystal plate of silicon carbide formed by a CVD method is incorporated, the adsorbing plate laminate being adopted as the purification method of the present invention in substitution for the adsorbent grain-packed column in the cleaning apparatus of FIG. 3.

FIG. 5 is a Cv-Cs double logarithmic relationship diagram illustrating Freundlich adsorption straight lines of Fe on silicon surfaces and silicon carbide surfaces.

FIG. 6 is a graph chart showing an EDTPO effect (relationship between V/S and remaining ⁵⁹Fe percentage) of SC1 cleaning with respect to Fe contamination of a silicon surface.

FIG. 7 are image photos showing measurement results of RLG images provided by an RI tracer method with radioactive iron adsorbing to a silicon surface and a silicon carbide surface.

### DESCRIPTION OF EMBODIMENTS

Hereinafter, a purification method and purification apparatus for an alkaline treatment liquid for a semiconductor substrate of the present invention are described in detail.

1. Form of Silicon Carbide Constituting Adsorption Purification Means

In the present invention, adsorption purification means for purifying an alkaline treatment liquid has only to have at least a silicon carbide crystal face which comes into contact with the alkaline treatment liquid. Any form of silicon carbide can be used without particular limitations as long as the silicon carbide crystal face is secured. However, amorphous silicon carbide can find limited applications because it is poor in chemical resistance and mechanical strength. Single crystal is preferred from the viewpoint of purity and in particular, has a small variation in adsorption performance. Silicon carbide with a hexagonal system and silicon carbide with a cubic system are used for a semiconductor device. The (0001) face of the former is usually used, and because the hexagonal system has a polymorphic feature, a 4H wafer and a 6H wafer are often commercially available. However, the difference thereof is negligible. The problem is that a single crystal of silicon carbide is polar and has a significant difference in Fe adsorption performance between its front surface and back surface. An RLG image of silicon carbide of FIG. 7 shows a surface adsorbing Fe more and the back surface sometimes shows half the adsorption performance of the front surface in the worst case. A cubic system occurs when epitaxial growth is caused on an Si wafer surface, and has a (100) face. The face has almost the same adsorption performance as that of the hexagonal system. The back surface is made of silicon, and hence there is no room for consideration of this case.

Wafer-shaped silicon carbide that is most available in the market is a polycrystal dummy wafer which is frequently used in a semiconductor process and is processed in an oxidation furnace, a diffusion furnace, a reduced-pressure CVD furnace, or the like. The polycrystal dummy wafer is produced mainly by a method in which silicon carbide is caused to grow on a graphite substrate by CVD so that the resultant silicon carbide film has a required thickness and then the graphite is removed by, for example, firing. However, problems of warpage, mechanical strength, roughness of finished surfaces, etc. occur, and different problems occur depending on the processes used. In order to meet various requirements, manufacturers have made efforts to supply various products in the market, and hence not a few patent publications relating to the production of a dummy wafer have been issued. A method in which ultrafine particles of silicon carbide are sintered into a wafer shape has long been carried out, and improvement of the method has solved a problem of a target purity, thus providing an improved product in the market. Further, an old method for direct silicification of graphite has been improved.

A silicon carbide CVD substrate is particularly important in the present invention. It is said that under a normal growth condition, each silicon carbide crystal has a cubic system, (111) faces and (110) faces are oriented in its surfaces, and the former case occurs more frequently at 1,600° C. or less. Observation with a microscope sometimes shows a rough face having a (111) square pyramid and a crystal whose shape is not identified. Fe usually adsorbs to both surfaces of a polycrystal substrate to almost the same extent, and this phenomenon is a very important advantage for Examples of the present invention in which both surfaces of an adsorbing plate are used. A wafer obtained by further subjecting a CVD wafer yielded by removing graphite to CVD to cause silicon carbide to grow is more desirable from such viewpoint of the advantage described above. However, it is not easy theoretically to pursue the advantage, and hence the inventors of the present invention chose a method in which judgment was done immediately by using an RLG method. That is, pieces each having an area of about 4 cm² were sampled from various kinds of CVD dummy wafers, and about ten pieces of the samples and several pieces of silicon (100) chips of 2 cm square were each placed on a ring-shaped chip tray made of a fluororesin which was well made so that the dipping condition of each chip was equivalent. The chip tray was dipped in an alkaline hydrogen peroxide cleaning liquid prepared so as to have a ⁵⁹Fe concentration of about 0.1 ppb in a quartz beaker, and each dried sample for an RI tracer method was produced in the same procedure as that in “3. Fe adsorption effect of silicon carbide surface and regeneration cleaning method applied to adsorbed Fe” described below. Radiological images of the front surface and back surface of each of all samples were taken at the same time, and the ⁵⁹Fe adsorption amount of each chip of the dummy wafer was compared with the average ⁵⁹Fe adsorption amount of the silicon chips.

The results of all dummy wafer samples showed that the variation in ⁵⁹Fe concentration between both surfaces was ±20%, which was good, and when the adsorption concentrations of the dummy wafer samples were compared with that of the silicon (100) face, the adsorption concentration of a dummy wafer sample was more than seven times higher than that of the silicon (100) face, which was a particularly good result. The adsorption concentrations of most dummy wafer samples were five times to six times higher, and the adsorption concentration of one dummy wafer sample was three times higher. The adsorption concentration of a surface of a (0001) silicon carbide single crystal chip simultaneously tested showed a good result and was five time higher, and the adsorption concentration of the back surface was 2.5 times higher. CVD silicon carbide polycrystal plates provide Fe adsorption performance which is most preferred in the present invention. Some of them have surfaces showing very good hydrophilicity, and hence they can have an enough area (silicon carbide crystal face) of contact with an alkaline treatment liquid, and the alkaline treatment liquid is easily separated after purification treatment, that is, they are excellent in so-called liquid releasing property.

Further, it is estimated that a grain-like crystal produced by a CVD method has, for example, a grain diameter of about several hundred μm, has a cubic system, and has a surface in which (111) faces are oriented, and hence the grain-like crystal is preferred as an adsorbent for a packed bed. A silicon carbide ingot produced by an Acheson method which has been widely used is pulverized into grains each having a grain diameter of several hundred rim, the grains are purified with chemical treatment or the like, the whole surface of each grain is then coated with a high-purity silicon carbide CVD film, and the resultant grain can also be used as an adsorbent for a packed bed.

2. Influence of EDTPO on Fe Contamination in Alkaline Treatment Liquid

When an alkaline hydrogen peroxide cleaning liquid including hydrogen peroxide is used as an alkaline treatment liquid, a trace amount of a chelating agent for preventing decomposition remaining in a hydrogen peroxide solution sometimes suppresses the adsorption of Fe to a silicon surface or a silicon carbide surface. Even a so-called high-purity hydrogen peroxide solution includes the chelating agent of this kind in a very small amount or does not include the chelating agent, depending on its manufacturer and production lot, or even if the chelating agent is included, it is not clear what substance the chelating agent is. Each Freundlich straight line showing the adsorption, to a silicon surface, of Fe contained in SC1 prepared by using each highest-purity hydrogen peroxide solution supplied by each manufacturer is randomly located in a region between the thin dotted lines above and below the thick solid line in FIG. 5, that is, a quite large range (under the same cleaning condition as that in the case of the thick solid line). The inventors of the present invention added an ethylenediamine tetramethylene phosphonic acid chelating agent (EDTPO) to COPO at 10 ppb. The result was not significantly influenced by the difference among each high-purity hydrogen peroxide solution, yielding the Freundlich straight line shown by the thin solid line in FIG. 5. A phosphonic acid chelating agent such as EDTPO has a very strong effect on the suppression of Fe adsorption to a silicon surface from SC1 and COPO (see Non Patent Literature 2 and Non Patent Literature 3). In order to study such effect on a silicon carbide surface, the inventors of the present invention first rewrote in FIG. 5 the Freundlich straight line indicating the addition of EDTPO at 1 ppm, the Freundlich straight line being shown by the inventors in both the literatures, and the inventors further plotted a Freundlich straight line newly prepared by using POCO to which EDTPO is added at 100 ppb and carrying out an experiment under the same condition as that in the latter.

3. Fe Adsorption Effect of Silicon Carbide Surface and Regeneration Cleaning Method Applied to Adsorbed Fe

In order to compare the Fe adsorption performance of the (0001) face of a 4H silicon carbide single crystal in a COPO cleaning liquid with that of the (100) face of a silicon single crystal to which Fe easily adsorbs, a simple adsorption experiment was carried out. Nine small beakers made of quartz glass and containing 10 mL of a COPO cleaning liquid were prepared. A ferric chloride aqueous solution labeled with radioactive ⁵⁹Fe was added dropwise into each beaker so that each liquid had an Fe concentration of a little less than 1 ppb. A silicon single crystal (100) wafer, an amorphous carbon wafer, and a 4H silicon carbide single crystal (0001) wafer were prepared. Sample chips of 2 cm square were cut from the two formers, and the small hard silicon carbide wafer was cut into four pieces by a cutting factory, yielding chips. Each chip was used as an experimental sample. Each sample was dipped in the COPO cleaning liquid with a temperature of 70° C. for ten minutes, was then rinsed with ultrapure water for ten minutes, and was dried. After that, the radioactivity of each sample was measured by an RI tracer method and the adsorption concentration of Fe on the surface of each sample was calculated.

Table 1 shows the results.

As evident from the results of the adsorption experiment shown in Table 1, the silicon carbide surface shows adsorption about four times as high as that of the silicon surface, serving as a ground for the superiority of the present invention. The comparison of RLG images of a silicon carbide chip surface (B) and a silicon chip surface (A) is as shown in FIG. 7. Exact measurement values of the radioactivity of the both are as shown previously. The density of each of the images observed with naked eyes is nearly proportional to each adsorption concentration of ⁵⁹Fe, and the difference in density between the both is immediately obvious. Further, the amorphous carbon surface showed Fe adsorption to a very small extent.

Further, each Si wafer preliminarily contaminated with radioactive iron (⁵⁹Fe) was used to perform a comparative cleaning test at room temperature in various cleaning liquids. First, dilute hydrofluoric acid, which allows ultrapure water rinse to be quickly finished, was selected, and a combination of dilute hydrofluoric acid and an oxidant was selected. After that, a cleaning test was performed at room temperature with respect to each sample used for the adsorption test. Fe on the silicon surface was able to be removed easily with dilute hydrofluoric acid, but Fe on the silicon carbide surface was not able to be removed sufficiently by dilute hydrofluoric acid cleaning, and Fe on the silicon carbide surface was able to be removed at a ratio of 98% when a hydrogen peroxide solution was added.

The results are additionally shown in Table 1.

On the basis of the results of the cleaning experiment shown in Table 1, the inventors of the present invention came up with a new idea and performed a cleaning experiment in the same manner except that ozone was added instead, yielding exactly the same cleaning effect. As a result, it was found that cleaning with dilute hydrofluoric acid in coexistence with an oxidant was suitable for regenerating the adsorption performance of an Fe-adsorbing silicon carbide surface. The composition of the cleaning liquid presented below is a 2-wt % hydrogen peroxide/1-wt % hydrofluoric acid aqueous solution, but the composition of a regeneration liquid is not limited to these values in consideration of the action.

TABLE 1

| | Adsorption | Cleaning | | |
|---|---|---|---|---|
| | Surface | | Surface | |
| | Concentration Cₛ | | concentration | |
| | (×10¹⁰ atoms/ | Cleaning | (×10⁹ atoms/ | Remaining |
| Sample | cm²) | method | cm²) | ratio (%) |
| Si | 50 | Dilute HF | 5 | 1 |
| SiC | 200 | | 700 | 35 |
| | | HF (1 wt %) + | 30 | 2 |
| C | 2 | H₂O₂ (2 wt %) | 1 | 6 |

4. Freundlich Adsorption Straight Line at Silicon Carbide Surface

Silicon carbide chips were used to perform an adsorption experiment under almost the same condition as that with the above-mentioned COPO cleaning liquid (in which EDTPO was added at 10 ppb). The adsorption concentration of a surface of a chip in a COPO cleaning liquid having an Fe concentration of 1 ppb and that in a COPO cleaning liquid having an Fe concentration of 0.1 ppb were measured, and the results were plotted in FIG. 5. As a result, the straight line (alternate long and short dash line) connecting the both was found to be almost parallel to the Freundlich adsorption straight line group already described. Thus, this straight line can be said to be a Freundlich adsorption straight line. This straight line is located far above the Freundlich straight line of silicon in a COPO cleaning liquid, and hence it was found immediately that silicon carbide was far more excellent in Fe adsorption performance compared with silicon.

FIG. 5 also has a Freundlich adsorption straight line (alternate long and short dash line) in the case of silicon carbide in a COPO cleaning liquid in which EDTPO was added at 100 ppb. The adsorption suppressing action of the chelating agent also works on silicon carbide. The chelating agent causes the Fe adsorption purification ability of silicon carbide to deteriorate and is a harmful substance in that sense. However, the Freundlich straight line is located quite near the straight line in the case of silicon in the COPO cleaning liquid. Thus, even when EDTPO is added to COPO at 100 ppb, the adsorption purification effect of silicon carbide is almost equal to the adsorption purification effect of silicon in the COPO cleaning liquid (in which EDTPO is added at 10 ppb). This shows that, even when EDTPO is added to an alkaline hydrogen peroxide cleaning liquid at about 0.1 ppm, silicon carbide can exert such an adsorption purification effect that no problem arises in practical use in terms of Fe adsorption purification performance in the liquid.

Radioactive ⁵⁹Fe was added to a choline stock solution (5-wt % choline aqueous solution) with room temperature in the same manner as described above, and a Freundlich adsorption straight line for a silicon carbide (0001) face was determined and shown as the alternate long and two short dashes line in FIG. 5. The line was located at the highest position among the straight line group. The result shows that Fe in an alkaline treatment liquid is more difficult to adsorb to silicon carbide from a hydrogen peroxide-containing cleaning liquid. It was suspected that treatment temperature maybe involved in the result, and hence the adsorption effects of the both were examined at room temperature, but as shown in Examples, almost the same results were given.

5. In Regard to Mechanism of Adsorption Behavior of Metal Impurities in Alkaline Treatment Liquid

It is well known that in an alkaline liquid, each of a silicon carbide surface, an Si surface, and an SiO₂ surface has a negative zeta potential, and its value of the SiO₂ surface is slightly larger than that of the Si surface. One example of the phenomenon described here is given below. The inference from the result concludes that silicon carbide has a much larger negative zeta potential. As described previously, ferric hydroxide dispersing in an alkaline liquid is a positive colloid, and hence more easily adsorbs to a quartz glass surface and an oxide film surface than to a silicon surface. However, when EDTPO is added to the alkaline liquid, the colloid turns into a negative ion, thereby being able to prevent the adsorption of the colloid.

The purpose of the following experiment is to verify the above-mentioned point. This time, 10 mL of COPO having a radioactive ⁵⁹Fe concentration of 12 ppt were transferred into each of five small beakers made of quartz glass, a silicon chip of 2 cm square was dipped in each of the beakers, and an Fe adsorption experiment was performed. In addition, EDTPO was added at 1 ppm to a choline cleaning liquid having the same radioactive ⁵⁹Fe concentration, the resultant liquid was transferred into five beakers in the same way as described above, and an Fe adsorption experiment was performed in the same manner as described above. When the dipping treatment of each chip was completed, each cleaning liquid was sampled in a predetermined amount and was dropped on filter paper for evaluation, followed by drying. The chip was taken out, rinsed, and then dried. The radioactivity of each case was measured by an RLG-RI tracer method in the same manner as describe above, and the Fe concentration of each liquid (liquid concentration) and the adsorption concentration of each silicon surface (Si surface adsorption concentration) were determined.

Average values in the respective cases were calculated. Table 2 shows the results.

TABLE 2

EDTPO 1 ppm

| | Not added | Added |
|---|---|---|
| Liquid concentration (ppt) | 7.4 | 11.8 |
| Si surface adsorption concentration | 56 | 3.0 |
| (×10⁸ atoms/cm²) | | |
| Total amount in liquid and on Si surface | 7.8 | 11.8 |
| (×10¹¹ atoms) | | |
| Adsorption amount of quartz surface | 42 | 2.2 (*1) |
| (×10¹⁰ atoms) | | |
| Adsorption concentration of quartz | 19 | 1 (*2) |
| surface (×10⁹ atoms/cm²) | | |

In consideration of the fact that the total area of the front and back surfaces of each of the chips is 8 cm², the total Fe adsorption amount of the whole Si surface is calculated on the basis of the Si surface adsorption concentration. The total Fe amount in the liquid calculated from the liquid concentration is added to the total Fe adsorption amount of the whole Si surface. Table 2 shows the resultant value as “Total amount in liquid and on Si surface.” The amount of Fe in the container is 1.2×10¹² atoms, and hence the Fe adsorption amount on the quartz inner surface of the beaker can be calculated by subtraction. Next, in consideration of the fact that the area of the part brought into contact with the liquid in the inner surface of the beaker is 22 cm², the adsorption concentration of the quartz surface can be calculated. The subtraction idea lacks reliability in the case of an EDTPO-added product, and hence the beaker was placed in a well type NaI scintillator, and the radioactivity was measured, thereby calculating the adsorption amount and adsorption concentration of the quartz surface (*1 and *2). The Fe adsorption concentration of the quartz surface is about three times larger than that of the silicon surface. An oxide film surface is an SiO₂ surface, thus showing the same tendency and having more adsorption. However, when a liquid has an Fe concentration of about 1 ppb, Fe adsorbs to the oxide film surface and the silicon surface to nearly the same extent, and rather, Fe tends to be slightly more difficult to adsorb to the oxide film surface. When an alkaline hydrogen peroxide cleaning liquid has an Fe concentration in a lower ppt region, a ferric hydroxide colloid dispersed in the liquid works as a positive colloid more strongly. As a result, adsorption differs between an SiO₂ surface and a silicon surface. On the other hand, when EDTPO is added, the ferric hydroxide colloid turns into a chelate compound, and hence it is clearly found that the adsorption of the colloid radically decreases.

In consideration of the above-mentioned adsorption behavior of metal impurities in an alkaline treatment liquid, and on the basis of the fact that silicon carbide has a superior ferric hydroxide positive colloid adsorption characteristic, it is possible to conclude that silicon carbide has a larger negative zeta potential than silicon. Further, it is found that, from the viewpoint that it is necessary, in a silicon substrate cleaning step, for a cleaning liquid to have a powerful removal action against Fe contamination and a suppression action against degradation due to bubbling caused by the liquid, EDTPO is preferably added in an alkaline treatment liquid used as the cleaning liquid, and silicon carbide used as adsorption purification means must endure the burden of the addition of EDTPO.

6. Freundlich Adsorption Equation of Fe with Respect to Silicon Carbide Surface and K Value

In the Freundlich adsorption straight lines in FIG. 5, when a silicon substrate or a silicon carbide substrate is dipped in an alkaline treatment liquid (hydrogen peroxide-containing cleaning liquid except one case) having an Fe concentration of Cᵥ (atoms/cm³), and the equilibrium of the Fe concentration of the liquid and the Fe adsorption concentration Cₛ (atoms/cm²) of a surface of the silicon substrate or a surface of the silicon carbide substrate is established, the following linear equation (where m and K represent constants and m represents a slope of a straight line) (Equation 1) is valid between Cᵥ and Cₛ.

[Math. 1]

log Cₛ=m log Cᵥ+log K (1)

Further, the following Freundlich adsorption equation (Equation 2) is derived from this equation 1.

[Math. 2]

Cₛ=KCᵥ^{m} (2)

The angle of the slope of this straight line group is about 45°. Thus, in order to simplify the discussion, the value of m in each case was set to 1. In this case, the above-mentioned Freundlich adsorption equation can be represented as the following equation 3.

[Math. 3]

Cₛ/Cᵥ≈K (3)

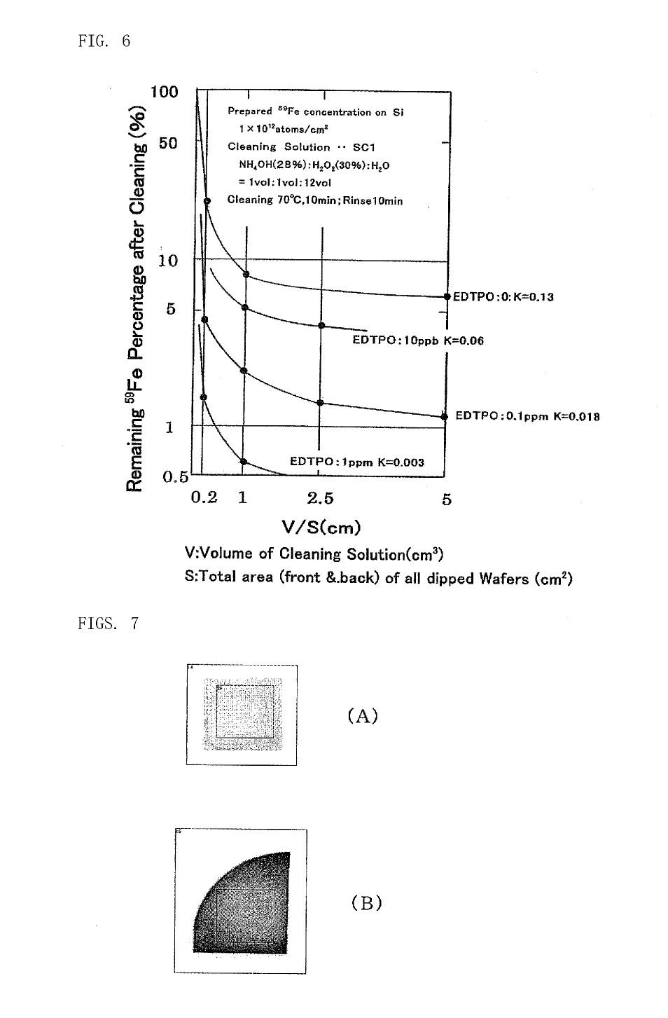

Thus, the K value approximately shows the adsorbability of Fe in a liquid to a silicon surface or a silicon carbide crystal face when the Fe concentration of the liquid is constant. The K value is additionally mentioned in FIG. 5 and FIG. 6 described later. In the case of the COPO cleaning liquid, whereas the K value of a silicon (100) substrate is 0.065, the K value of a surface showing more adsorption of a silicon carbide (0001) substrate is 0.25, which is nearly four times as high as that of the silicon substrate.

7. Adsorption Purification Experiment of Fe (Fe Adsorption Purification Experiment) Using Silicon Carbide Wafer

Two silicon carbide CVD dummy wafers (with a polycrystal face) each having a diameter of 200 mm were used, and a spacer cut from a polytetrafluoroethylene (PTPE) resin sheet so as to have a thickness of 0.5 mm and a width of 10 mm was interposed and fixed between these two wafers at their circumferential portions. Further, the spacer was partially cut at its top and bottom portions, thereby forming apertures, and a test liquid of an alkaline treatment liquid was introduced into the slit gap between both the wafers, thereby preparing an adsorbing plate laminate for testing for investigating the adsorption performance of the inner surfaces of the wafers. This adsorbing plate laminate for testing was used, and the inside of the slit gap was first cleaned with dilute hydrofluoric acid containing hydrogen peroxide, was rinsed, and was then dried by blowing a nitrogen gas. Next, a test liquid (prepared by adding a predetermined amount of radioactive ⁵⁹Fe to a COPO cleaning liquid with room temperature) was introduced into the slit gap, was kept as it was for one minute, and was then discharged. The test liquid was recovered and its radioactivity was measured, thereby calculating the remaining ratio of radioactive ⁵⁹Fe remaining in the test liquid.

In regard to the above-mentioned adsorbing plate laminate for testing, when the volume of the test liquid introduced into and filling the slit gap is represented by V cm³, the area of the portions in contact with the test liquid in the adsorbing plate laminate for testing is represented by S cm², the Fe concentration of the test liquid measured before being introduced into the slit gap is represented by C_{VI}, and the Fe concentration of the test liquid when the test liquid introduced into and filling the slit gap is left to stand and an equilibrium is established is represented by C_{VA}, as long as the Freundlich adsorption rule is valid at this concentration, the remaining ratio of radioactive “Fe after adsorption purification is represented by the following equation 4 on the basis of the Freundlich adsorption equation represented by the above-mentioned equation 3.

[Math. 4]

C_{VA}/C_{VI}=1/[1+K(S/V) ] (4)

The remaining ratio obtained as a result of the experiment was about 9%. The liquid contact area of each wafer used in the experiment is 240 cm², that is, S=480, and the volume of the slit gap is V=12, thus resulting in S/V=40. When C_{VA}/C_{VI}=0.09, K=0.22 results on the basis of the equation 4. The K value of the CVD polycrystal silicon carbide was nearly that of single crystal silicon carbide.

That is, it is estimated that when the Fe concentration of an alkaline treatment liquid is a value at a low level, for example, a value in a lower ppt region, the Freundlich rule is valid at a high K value in regard to a silicon carbide crystal substrate surface regardless of single crystal or polycrystal. When an adsorbing plate laminate in which the distance between substrates is as narrow as 0.5 mm and has a gap of S/V=40 is used, such satisfactory purification as described above can be carried out. A CVD polycrystal substrate has the same adsorption characteristic at its front and back surfaces unlike a single crystal substrate and can have a rather high K value in comparison to a single crystal face, and hence the gap between the CVD polycrystal substrates can probably be broadened.

Further, these silicon carbide plate-like substrates are chemically more stable and mechanically more stable in comparison to silicon carbide grains regardless of single crystal or polycrystal, and hence have the effect of remarkably reducing a burden on a filter for removing fine particles that follows.

### EXAMPLES

The purification method and purification apparatus for an alkaline treatment liquid according to the present invention are described below by way of examples, but the present invention is not limited to the following examples.

Here, used as high-purity materials used for preparing alkaline treatment liquids used in the following examples were a 25-wt % TMAH aqueous solution having an Fe concentration of 1 to 0.3 ppb or less, a 4-wt % choline aqueous solution having an Fe concentration of 0.3 to 0.05 ppb or less, 29-wt % ammonia water having an Fe concentration of 0.1 to 0.05 ppb, and a 30-wt % hydrogen peroxide solution having an Fe concentration of 0.1 to 0.03 ppb. Further, members to be brought into contact with the alkaline treatment liquid, such as containers, pipes, valves, pumps, and filters, which were used in the examples were members each made of a fluororesin (mainly PTFE). All the members were repeatedly subjected to ultrasonic heating cleaning using a TMAH treatment liquid to which a surfactant had been preliminarily added and nitric hydrofluoric acid cleaning a plurality of times, to thereby remove metal contamination.

### Example 1

Two silicon carbide single crystal (6H) wafers each having a diameter of 75 mm were used to take preliminarily atomic force microscope (AFM) images of the mirror surfaces of these wafers. After that, the mirror surfaces were positioned so as to face to each other, and an adsorbing plate laminate having a slit gap with a gap of 0.5 mm of Example 1 was formed in the same manner as that in the Fe adsorption purification experiment described previously.

Radioactive ⁵⁹Fe was added into the above-mentioned 5-wt % choline aqueous solution, yielding a test liquid having a radioactive ⁵⁹Fe concentration of 100 ppt, and the adsorbing plate laminate of Example 1 and the test liquid were used to carry out an Fe adsorption purification experiment under room temperature in accordance with the same procedure as that in the Fe adsorption purification experiment described previously, thereby calculating the remaining ratio of radioactive ⁵⁹Fe in the test liquid.

After that, the inside of the slit gap in the adsorbing plate laminate of Example 1 was cleaned in the same manner as described above. Then, the above-mentioned 25-wt % TMAH aqueous solution was diluted ten-fold, yielding a 2.5-wt % TMAH aqueous solution. Radioactive ⁵⁹Fe was added into the 2.5-wt % TMAH aqueous solution, yielding a test liquid having a radioactive ⁵⁹Fe concentration of 100 ppt. The test liquid was used to carry out an Fe adsorption purification experiment under room temperature in accordance with the same procedure as that in the Fe adsorption purification experiment described previously, thereby calculating the remaining ratio of radioactive ⁵⁹Fe in the test liquid.

In both experiments, the removal ratio of radioactive ⁵⁹Fe was 90% or more, and hence it was found that a satisfactory purification effect was exerted. It is estimated that Fe Freundlich adsorption straight lines of the both with respect to a silicon carbide surface at room temperature are, as shown in FIG. 5, located at a position quite close to the downward extended line of the straight line of the choline stock solution in the ppt region.

After that, performed was an experiment for evaluating chemical durability in which the slit gap was filled with the latter, which was a non-radioactivated test liquid (25-wt % TMAH aqueous solution), and the resultant was left to stand for 30 hours. Then, the test liquid was discharged and the inside of the slit space was cleaned in the same manner as described above. After that, the adsorbing plate laminate was broken down and AFM images of the surfaces of the silicon carbide wafers were taken in the same manner as that before the treatment. The AFM images before the treatment and those after the treatment were compared, but no difference was found. Thus, the experiment for evaluating durability did not discover any sign indicating that the surfaces of the silicon carbide wafers had been etched.

### Comparative Example 1

An Fe adsorption purification experiment was carried out in the same manner as that in Example 1, except that two Si wafers each having a diameter of 200 mm were used instead of the silicon carbide wafers and a liquid contact tool prepared in the above-mentioned Fe adsorption purification experiment was used.

Example 1 and this Comparative Example 1 both showed S/V=40, but the removal ratio in this Comparative Example 1 was less than 80%. Further, in the experiment for evaluating chemical durability in which a non-radioactivated test liquid is left to stand for 30 hours in a slit gap, remarkable surface roughness was observed with naked eyes on the surfaces of the Si wafers.

### Example 2

Based on the findings of the Example 1, an adsorbing plate laminate 1 illustrated in FIGS. 1(a) to 1(c) was constructed as adsorption purification means for an alkaline treatment liquid. The adsorbing plate laminate 1 is constituted of a set of 11 adsorbing plates 2 each having a thin plate shape cut out from a CVD polycrystal dummy wafer (K≈0.3, front and back surfaces with good hydrophilicity) having a thickness of 0.6 mm by a laser process so as to have a size of 100 mm by 102 mm and a holding cassette 3 made of a fluororesin (PTFE) for holding the adsorbing plates 2 with a predetermined interval (usually 0.8 to 3.0 mm, preferably 1 to 2 mm) to each other, with a parallel state to each other, with the state of facing to each other. Further, the holding cassette 3 is constituted of a cassette ceiling portion 4 having a recessed portion 6 for connecting to a robot arm (not shown) for transporting and positioning the adsorbing plate laminate 1 and a pair of cassette arm portions 5 which are positioned from both ends of the cassette ceiling portion 4 toward the vertical and downward direction and each have 11 adsorbing plate-fixing grooves 7 in the inner sides facing to each other. Further, the 11 adsorbing plates 2 are fixed to the holding cassette 3 in the state that both end portions of each of the adsorbing plates 2 are inserted in each of the adsorbing plate-fixing grooves 7 of each of the cassette arm portions 5. In this Example 2, the 11 adsorbing plate-fixing grooves 7 formed in each of the cassette arm portions 5 each have a depth of about 1 mm with a distance between grooves of 2 mm so that each of the adsorbing plates 2 having a surface area of 100 mm by 100 mm faces to each other with a distance of 2 mm in the state that each of the adsorbing plates 2 is fixed to the holding cassette 3.

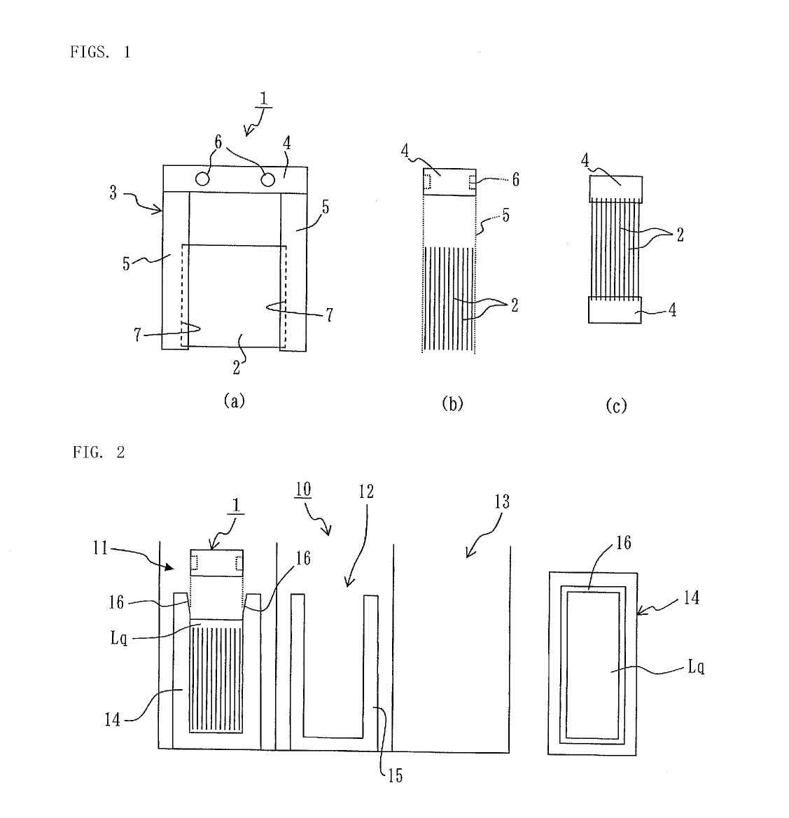

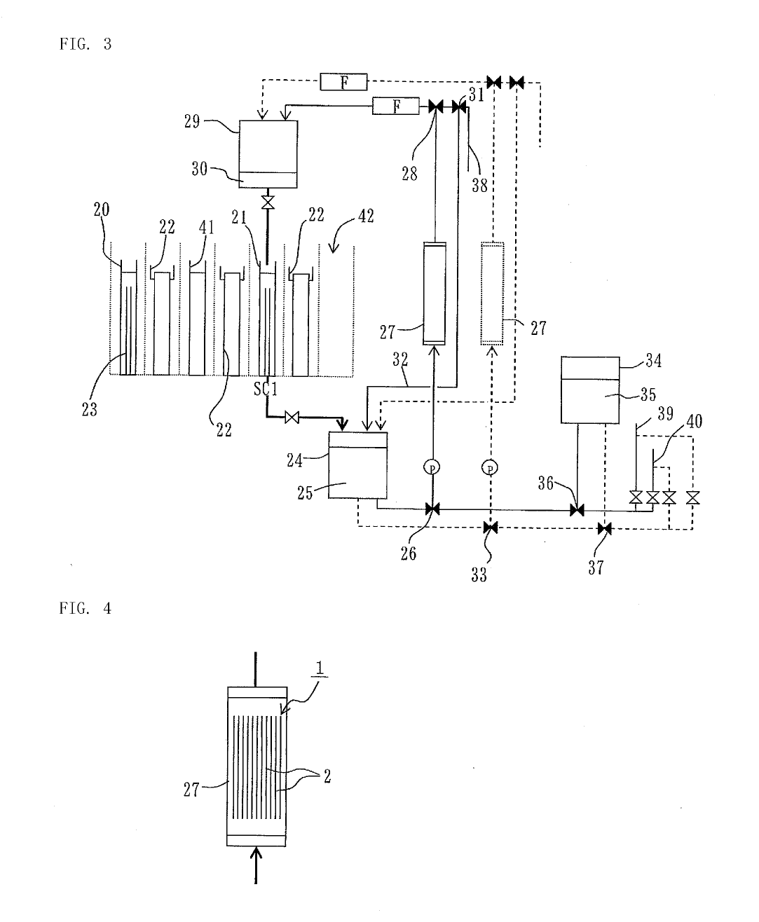

Further, FIG. 2 illustrates a treatment liquid purification apparatus 10 which is used when an alkaline treatment liquid (liquid to be purified) is purified by using the adsorbing plate laminate 1 of this Example 2. The purification apparatus 10 is provided with a liquid-to-be-purified purification region 11 for purifying a liquid to be purified Lq, an adsorbing-plate-laminate cleaning region 12 for cleaning the adsorbing plate laminate 1 after being used for purifying the liquid to be purified Lq in the liquid-to-be-purified purification region 11, and an adsorbing-plate-laminate drying region 13 for drying the adsorbing plate laminate 1 cleaned in the adsorbing-plate-laminate cleaning region 12, so that the adsorbing plate laminate 1 after being used for purifying the liquid to be purified Lq is regenerated via the adsorbing-plate-laminate cleaning region 12 and the adsorbing-plate-laminate drying region 13. Further, the liquid-to-be-purified purification region 11 is provided with an adsorption purification tank 14 for storing the liquid to be purified Lq, and includes a mechanism (not shown) for sending the liquid to be purified Lq from a region outside the liquid-to-be-purified purification region 11 into the tank 14 and sending the liquid to be purified Lq after purification from the liquid-to-be-purified purification region 11 into an outside region. In addition, the adsorbing-plate-laminate cleaning region 12 is provided with a cleaning tank 15 for cleaning the adsorbing plate laminate 1 after completion of purification treatment and includes a mechanism (not shown) for sending a cleaning liquid and ultrapure water for rinse to be used in the tank 15 sequentially from a region outside the region 12 into the tank 15 and discharging each of the used cleaning liquid and used ultrapure water after the treatment out of the region 12. Note that the adsorption purification tank 14 is provided with a slope guide plane 16 at the peripheral portion of its upper aperture so that the adsorbing plate laminate 1 is easily introduced into the adsorption purification tank 14 when the adsorbing plate laminate 1 is introduced into the adsorption purification tank 14 by operating the robot arm (not shown).

Further, in this Example 2, the adsorption purification tank 14 is designed to have a structure for receiving the adsorbing plate laminate 1 while keeping as small a gap as possible, is designed so that when a predetermined amount of the liquid to be purified Lq is injected into the adsorption purification tank 14 and the adsorbing plate laminate 1 is then introduced therein, the upper edge of each of the adsorbing plates 2 sinks slightly below the liquid surface of the liquid to be purified Lq in the adsorption purification tank 14, and is designed so that the adsorbing plate laminate 1 can be slightly moved up and down by a mechanism (not shown) in the adsorption purification tank 14.

Thus, when the liquid to be purified Lq is purified in the adsorption purification tank 14 by using the above in this Example 2, the adsorption purification tank 14 which has been cleaned is first positioned exactly at a predetermined place in the liquid-to-be-purified purification region 11, a predetermined amount of the liquid to be purified Lq is sent into the adsorption purification tank 14, the adsorbing plate laminate 1 which has been cleaned and is present in the adsorbing-plate-laminate drying region 13 is sent by a robot into the liquid to be purified Lq in the adsorption purification tank 14 and is sunk in the liquid, and the adsorbing plate laminate 1 is slightly moved up and down, bringing each of the adsorbing plates 2 into contact with the liquid to be purified Lq for a predetermined time.

Next, after completion of the adsorption purification operation in which each of the adsorbing plates 2 is brought into contact with the liquid to be purified Lq, the adsorbing plate laminate 1 is pulled up and transferred into the adsorbing-plate-laminate cleaning tank 15 positioned in the adsorbing-plate-laminate cleaning region 12. Here, the distance between the adsorbing plates 2 constituting the adsorbing plate laminate 1 is set to be 0.8 mm or more and 3.0 mm or less, the surfaces of each of the adsorbing plates 2 are hydrophilic, and hence high efficiency in the contact between each of the adsorbing plates 2 and the liquid to be purified Lq can be provided. In addition, when each of the adsorbing plates 2 is pulled up from the liquid to be purified Lq, the amount of the liquid to be purified Lq remaining in the gaps between the adsorbing plates 2 can be reduced to the smallest amount possible, and moreover, the remaining liquid to be purified Lq can be returned easily and certainly into the adsorption purification tank 14 by means such as blowing of high-purity nitrogen. Further, in the adsorbing-plate-laminate cleaning tank 15, the adsorbing plate laminate 1 is subjected to a cleaning operation by means such as water washing, cleaning with an adsorbing plate cleaning agent such as a 2 -wt % hydrogen peroxide/1 wt % hydrofluoric acid aqueous solution, or overflow rinse with ultrapure water.

Then, after completion of the cleaning operation of the adsorbing plate laminate 1 in the adsorbing-plate-laminate cleaning region 12, the adsorbing plate laminate 1 is transferred into the subsequent adsorbing-plate-laminate drying region 13 in the purification apparatus 10, and is dried by means such as blowing of a high-pressure nitrogen gas to be regenerated.

The adsorbing plate laminate 1 thus regenerated is used again and again for the adsorption purification of the liquid to be purified Lq in the liquid-to-be-purified cleaning region 11 in the purification apparatus 10.

The above is a primary adsorption purification operation of the liquid to be purified Lq performed by using the adsorbing plate laminate 1. When, for example, the liquid to be purified Lq in the adsorption purification tank 14 does not achieve a desired purity through the primary adsorption purification operation, the above-mentioned adsorption purification operation can be repeated a plurality of times, for example, secondary, tertiary, and quaternary adsorption purification operations can be performed, if necessary, depending on the degree of the purification of the liquid to be purified Lq or until desired high purification is achieved.

A specific example of the adsorption purification of an alkaline treatment liquid based on this Example 2 is given below.

The construction of the adsorbing plate laminate 1 was such that the distance between the adsorbing plates 2 was 2 mm, a 4-wt % choline aqueous solution having a radioactive ⁵⁹Fe concentration of 100 ppt was used as the liquid to be purified Lq, 300 mL of the liquid to be purified Lq were fed into the adsorption purification tank 14, the predetermined time of the contact of each of the adsorbing plates 2 and the liquid to be purified Lq was set to one minute, the regeneration operation of the adsorbing plate laminate 1 was performed, and the adsorption purification operation was repeated four times.

When these primary to quaternary adsorption purification operations were performed, 1 mL of the purified liquid to be purified Lq was collected after each adsorption purification operation, and the collected liquid was dropped on filter paper for measurement, followed by drying. The filter paper was exposed to light (exposed to light for a long period of several ten days in the case of filter paper having a low concentration) with an imaging plate, and an RLG-RI tracer method was used to determine the concentration of Fe remaining in the liquid to be purified Lq after each adsorption purification operation.

The results were 26 ppt after the primary purification, 6 ppt after the secondary purification, 1.2 ppt after the tertiary purification, and 100 ppq after the quaternary purification. The value (100 ppq) after the quaternary purification indicates that a purification accelerating phenomenon occurred in a low concentration region as in the case of Non Patent Literature 3. This fact shows that an unexpected purification effect is provided in a low concentration region even if S/V is as low as about 10.

### Example 3

In order to use high-purity silicon carbide grains each having a grain diameter of 0.2 to 1.2 mm (GNF-CVD manufactured by Pacific Rundum Co. Ltd.), which are a single crystal material, as an adsorption purification agent, the silicon carbide grains were dipped and cleaned preliminarily in each of a choline stock solution and nitric acid for several days. After that, a fluororesin column having an inner diameter of 20 mm and a length of about 120 mm was filled with 60 g of the cleaned silicon carbide grains (an apparent volume of about 30 mL), thereby constituting an adsorbent-packed column. 500 mL each of various liquids were passed through the column, starting from a 7-wt % nitric acid aqueous solution, followed by ultrapure water, 2-wt % hydrofluoric acid/1-wt % hydrogen peroxide aqueous solution, and ultrapure water, in the stated order, and then a purification experiment of a test liquid was performed.

Further, a 4 wt % choline aqueous solution (choline stock solution) was used as an alkaline treatment liquid (liquid to be purified), and 500 mL of the liquid to be purified were passed through the adsorbent-packed column at a rate of 20 mL/minute. Sampling was performed before passing the liquid through the column, after passing 300 mL of the liquid, after passing 400 mL of the liquid, and after passing 500 mL of the liquid. Each of the samples was subjected to inductively coupled plasma mass spectrometry (ICPMS) to analyze the concentration of metal impurities.

The results are shown in Table 3 (unit: ppt).

TABLE 3
Unit: ppt

| Element | Before passing | | | |
|---|---|---|---|---|
| measured | liquid | 300 mL | 400 mL | 500 mL |
| Na | 54 | 14 | 24 | 37 |
| Mg | 34 | 30 | 30 | 30 |
| Al | 64 | 61 | 60 | 61 |
| K | 57 | 46 | 43 | 44 |
| Ca | 176 | 42 | 41 | 40 |
| V | 32 | 32 | 32 | 32 |
| Cr | 101 | 106 | 99 | 98 |
| Mn | 32 | 27 | 27 | 25 |
| Fe | 474 | 80 | 79 | 76 |
| Ni | 99 | 103 | 69 | 90 |
| Co | 18 | 19 | 17 | 20 |
| Zn | 68 | 37 | 39 | 40 |

As evident from the results shown in Table 3, Fe and Ca, which are liable to turn to hydroxide positive colloids, can be removed to the extent of remaining ratios of 16% and 23%, respectively. However, it was found that Al, Cr, Ni, etc., which form hydroxo complex ions in a strongly basic aqueous solution, were not able to be removed.

### Example 4

Adsorption purification through the adsorbent-packed column was performed in the same manner as that in Example 3 above, except that a liquid to be purified was prepared as an alkaline treatment liquid by adding, to COPO, 500 ppt each of aluminum (Al), calcium (Ca), and chromium (Cr), and 120 ppt of iron (Fe). Metal impurities before and after passing the liquid through the column were analyzed by ICP mass spectrometry.

The results are shown in Table 4 (unit: ppt).

TABLE 4
Unit: ppt; ND < 10 ppt

| | Before | | | | | | | | | |
|---|---|---|---|---|---|---|---|---|---|---|
| Element | Passing | | | | | | | | | |
| measured | liquid | 100 mL | 200 mL | 300 mL | 400 mL | 500 mL | 600 mL | 700 mL | 800 mL | 900 mL |
| Al | 506 | 70 | 97 | 144 | 156 | 173 | 183 | 196 | 196 | 215 |
| Ca | 531 | ND | ND | ND | ND | ND | ND | ND | ND | ND |
| Cr | 528 | 425 | 497 | 507 | 525 | 511 | 517 | 507 | 521 | 512 |
| Fe | 124 | 28 | 32 | 34 | 39 | 32 | 35 | 32 | 34 | 33 |
| Ni | ND | ND | ND | ND | ND | ND | ND | ND | ND | ND |
| Cu | ND | ND | ND | ND | ND | ND | ND | ND | ND | ND |

As evident from the results shown in Table 4, the adsorption performance for Al lowers fast, but the purification action thereon is sufficiently exerted. Further, the purification effect on Ca is extremely high, but the purification effect on Cr is hardly exerted. When an Si wafer is subjected to alkaline hydrogen peroxide cleaning, Cr is difficult to adsorb to the cleaning surfaces of the Si wafer, and hence the result does not involve any problem. The remaining ratio of Fe was slightly worse than that in the case of a 4-wt % choline aqueous solution, and was about 27%, but the result shows a satisfactory purification effect in regard to whether the purpose of the present invention is achieved. The result of Fe is almost the same as that in the case where silicon is used as an adsorbent. When the K value of silicon carbide grains is 0.2, the calculation based on the equation 4 comes to S/V=25. It was estimated that the result occurred because the size distribution of the silicon carbide grains used was wide, fine grains filled the gaps between large grains, and hence unexpectedly, V was a small value. After 900 mL of the liquid were passed, 8.5-wt % dilute nitric acid was passed, followed by analysis. As a result, it was found that about 90% of the metals which had adsorbed to the grains were able to be removed. Oxidizing dilute acid was also very effective for cleaning the contaminated surfaces of silicon carbide grains.

### Example 5

Adsorption purification through the adsorbent-packed column was performed in the same manner as that in Example 3 above, except that a 4-wt % choline aqueous solution (liquid to be purified) having an Fe concentration of 37 ppt and a Ca concentration of 17 ppt was used as an alkaline treatment liquid and the liquid to be purified was passed through the column a large number of times until 2,000 mL of the liquid were passed. Metal impurities before and after passing the liquid through the column were analyzed by ICPMS, and the lifetime of the adsorbent in the adsorbent-packed column was examined. The results are shown in Table 5 (unit: ppt).

TABLE 5

| | Before | | | | |
|---|---|---|---|---|---|
| Element | Passing | | | | |
| measured | liquid | 500 mL | 1000 mL | 1500 mL | 2000 mL |
| Fe | 37 | ND | ND | ND | ND |
| Ca | 17 | ND | ND | ND | ND |

Because the purification action of a silicon carbide crystal face is attributed to chemical adsorption, the number of its adsorption sites is limited. Thus, as an object to be purified has lower concentrations of impurities, the adsorption sites are occupied by the impurities more slowly. In the case of intending to achieve lower concentrations in a sample including impurities at low concentrations as in the present invention, a more preferred effect can be expected in regard to regeneration frequency. This result shows that frequent regeneration is not necessary in a high-purity region.

### Example 6

Dilute hydrofluoric acid (DHF) cleaning is generally performed as a cleaning method used for removing Fe contamination of a silicon substrate surface. However, according to literatures, DHF cleaning has a limit at an Fe concentration of about 1×10¹⁰ atoms/cm², and when the inventors of the present invention made studies on Fe concentration by using an RI tracer method, the Fe concentration varied in the region of (2 to 0.5)×10¹⁰ atoms/cm². When the inventors of the present invention dipped silicon wafers for ten minutes in radioactive H¹⁸F-labeled DHF having a concentration of 0.1%, the adsorption amount of ¹⁸F reached 10¹³ atoms/cm² on average, and hence the inventors of the present invention understood from RLG images of the silicon wafers that ¹⁸F adsorption was liable to be locally present in a defective region. The half-life of ¹⁸F is short. When the radioactivity of ¹⁸F on the silicon wafers reduced to a level at which RLG images were not able to be taken, the inventors again dipped the wafers in pure water including ⁵⁹Fe for ten minutes, compared the pattern in the RLG images of the wafers to which ⁵⁹Fe adsorbed with the pattern of ¹⁸F, and found that both patterns agreed to each other to a significant extent. Then, the inventors of the present invention have reached the hypothesis that F is first captured by defects of a silicon surface in DHF cleaning and then Fe binds to F and remains. Therefore, the inventors of the present invention have reached the conclusion that the concentration of Fe remaining on a silicon surface after DHF cleaning can be reduced to a cleanness level required when the silicon surface is treated by the means that the silicon surface is slightly etched with an alkaline hydrogen peroxide cleaning liquid having undergone adsorption purification with silicon carbide according to the present invention, Fe is converted to complex Fe ions with a chelating agent, and the ions are dispersed in the liquid. In this example, the inventors of the present invention produced a cleaning experiment machine with a set of two wafers while having in mind a cleaning sequence based on the RCA method widely used, that is, a cleaning apparatus including the process of SPM (sulfuric acid-hydrogen peroxide treatment), SC1→DHF→SC2 (hydrochloric acid-hydrogen peroxide treatment), and verified the above-mentioned conclusion on the cleaning of Fe.

FIG. 3 is a conceptual diagram of this apparatus. The reason why the process usually starts from SPM, which exerts a powerful organic contaminant-removing ability, is that, when dry etching necessary for forming a device pattern is performed, contamination of metals such as Fe is liable to occur in the side or bottom of each fine pore produced, contamination of organic substances also occurs at the same time, and hence the latter needs to be removed at first. Thus, this experiment apparatus was also produced so as to include the process in which SPM cleaning first starts, DHF cleaning then follows, and SC1 cleaning provided with a cyclic silicon carbide adsorption purification mechanism is performed finally. Judging from the experience that it is difficult to clean Fe on an oxide film surface having fine irregularities, used as a sample to be cleaned was an oxidized wafer having a roughened surface produced by processing an Si wafer with a TMAH aqueous solution so as to have a roughened surface and applying thermal oxidation to the roughened surface. The sample wafer was contaminated with ⁵⁹Fe at a concentration of about 1×10¹² atoms/cm² in an SC1 liquid and was then left to stand in a plastic case for 72 hours to cause organic contamination. Before the start of a cleaning experiment, the ⁵⁹Fe concentration of the rough surface of the resultant wafer was accurately measured by an RLG method, and the wafer was used as a sample for a cleaning experiment performed by using an RI tracer method.

In order to achieve 5×10⁸ atoms/cm² as the concentration of Fe remaining on the surface of the silicon wafer after the final SC1 cleaning, when the concentration of Fe remaining on the surface after DHF cleaning is 2×10¹⁰ atoms/cm², the ability of the SC1 to clean Fe must be equivalent to a remaining ratio of 4% or less in view of the foregoing. SC1 varies in etching rate depending on its composition. In general, as the etching degree of SC1 is larger, the effect of removing foreign matter on a surface is exerted more strongly, but the surface is roughened, and hence the composition of SC1 needs to be determined depending on the purpose of treatment. However, a cleaning effect on Fe differs depending on the brands of a hydrogen peroxide solution even if the composition of the brands is the same, and the remaining ratio of Fe varies from about 6% to 12% under a normal cleaning condition. In this Example 6, the composition of SC1 was set to ammonia water:hydrogen peroxide solution:water=1:1:12 in volume. However, as shown in Non Patent Literatures 2 and 3, when a phosphonic acid-based chelating agent is added to SC1 and COPO, the remaining ratios of Fe in both can be reduced dramatically. The cleaning effect on Fe significantly depends on a V/S value in alkaline hydrogen peroxide cleaning, and hence the inventors of the present invention first determined a relationship between the remaining ratio of Fe after SC1 cleaning and a V/S value on the basis of the addition amount of EDTPO (a typical phosphonic acid chelating agent) described previously (FIG. 6). From the economic point of view, a smaller amount of a treatment liquid, that is, a smaller value of V/S, is preferred, but the cleaning effect of the treatment liquid reduces, and hence the ratio is about 0.8 to 1.25 in a practical cleaning apparatus. Thus, this experiment apparatus was designed so as to have a value of V/S=1. Two sample wafers each having a diameter of 150 mm were used. The experiment apparatus was designed so as to set the sample wafers, with a quartz glass chuck with a dedicated handle, to a quartz glass treatment tank with a wafer holder having a cleaning liquid amount of 700 mL.

The cleaning portion with SC1 was provided with the adsorbent-packed column of the present invention in front of a filter for particles by following the SC1 liquid circulation system, which mainly intends to improve the particle-removing ability of an existing cleaning apparatus and save the amount of a chemical liquid. However, when EDTPO is added to an alkaline treatment liquid, as the addition amount of EDTPO increases, the position of the resultant Freundlich straight line comes down as in the case of silicon in FIG. 5 even if silicon carbide is used. For example, the upper alternate long and short dash line indicating the case of a COPO to which EDTPO is added at 10 ppb comes down to the lower alternate long and short dash line when EDTPO is added to a COPO at 100 ppb. This means that the adsorption purification of Fe with silicon carbide becomes difficult. When an SC1 and a COPO each having the same addition concentration of EDTPO are used for a silicon surface, the Freundlich straight lines of both cases are substantially identical. This is true for a silicon carbide surface as well. Thus, the lower alternate long and short dash line is not significantly different from the Freundlich straight line for the case of silicon carbide dipped in SC1 to which EDTPO is added at 100 ppb. This line is quite close to the COPO (EDTPO: added at 10 ppb) line of silicon. This indicates that when SC1 to which EDTPO is added at 100 ppb is passed through the adsorbent-packed column of the present invention, provided is almost the same removal ratio as that of the case where SC1 to which EDTPO is not added is passed through the same type of silicon grain-packed column as that described in Non Patent Literature 3. In this Example 6, the same effect as that in Example 3 was targeted, and hence preparation was performed so that the volume of the silicon carbide grain-packed bed is proportional to the rate of supplying a liquid to the bed, that is, 200 mL of a liquid per minute can be passed through about 300 mL of a column (a column having an inner diameter of 6 cm and a height of a little less than 12 cm), which is equivalent to 10 times the volume of the grains. Further, silicon carbide grains were classified with a sieve to use as an adsorbent so that a similar grain size distribution to that of the silicon grains was achieved, and a preliminary test was performed with respect to the column by an RI tracer method in the same manner as that in the literature. The removal ratio of Fe was 82%.

Thus, when this SC1 circulation cleaning is started with a 100 ppb-EDTPO-added SC1 liquid, the SC1 liquid has a sufficient cleaning force in addition to the condition of V/S≈1, and hence, if the average Fe contamination concentration of wafers to be cleaned is 2×10¹⁰ atoms/cm², the purified wafers after the cleaning have an average Fe contamination concentration of about 4×10⁸ atoms/cm². Most of the removed Fe transfers into the liquid, and the Fe concentration of the SC1 liquid entering the purification column is 2×10¹⁰ atoms/cm³, that is, nearly 2 ppt. If 75% of the amount of Fe is removed, the resultant liquid returning to the cleaning tank has an Fe concentration of 5×10⁹ atoms/cm³, and Fe removed from the wafers in the next cleaning is added to the liquid at a ratio of about 2×10¹⁰ atoms/cm³. When the solid line indicating the case of 100 ppb-EDTPO-added COPO in FIG. 5 is extended downward, the solid line being able to be assumed as the Freundlich straight line indicating the case of 100 ppb-EDTPO-added SC1 on the basis of the description in the foregoing, the Fe concentration of the cleaned wafers is balanced with the Fe concentration in this liquid tank and only slightly increases from 4×10⁸ atoms/cm².

The experiment apparatus of the present invention illustrated in FIG. 3 is specifically described on the basis of the above.

A container for SPM treatment 20 and a container for SC1 treatment were lined up with overflow rinse tanks (such as a container for rinse 22 and a container for DHF treatment 41) being sandwiched by the containers, and drying of wafers was performed after the wafers were transferred to a single wafer spinner. Two wafers to be cleaned 23 which are treated simultaneously are moved manually with the handle of the quartz glass chuck (not shown) described previously. Cleaning treatment in each container including cleaning treatment with SC1 is performed by a general operation, and the specific description of this sequence is omitted because the specific description is not directly related to the present invention. Circulation purification means playing a vital role in the SC1 liquid circulation system in which adsorption purification with silicon carbide is incorporated opens a valve located below the container for SC1 treatment 21, passes an SC1 liquid 25, which is stored in a storage container 24 for a treatment liquid to be purified (SC1 liquid), through a first adsorbent-packed column (hereinafter referred to as “first column”) 27 prepared according to Example 3 above at a flow rate at which the liquid with a volume of half to two thirds of the volume of the adsorbent grains flows every minute with a liquid sending pump P via a three-way valve 26, and sends the liquid into a storage container (provided with a heating mechanism) 29 for a purified treatment liquid (SC1 liquid) via a three-way valve 28 and a particle-removing filter F. When cleaning is performed, the circulation purification means opens a valve located below the container 29, send the purified treatment liquid 30 in the container 29 at once to fill the container for SC1 treatment 21 in which wafers are set, performs cleaning for a predetermined time, then open the valve located below the container for SC1 treatment 21, and returns the liquid contaminated by impurities on the wafers into the storage container 24 at once. Then, the SC1 liquid is promptly substituted with a new one by causing the purified treatment liquid 30 to flow at once from the storage container (provided with a heating mechanism) 29 for a purified treatment liquid to fill the container for SC1 treatment 21, after almost all liquid in the container for SC1 treatment 21 is sent out, thereby being able to take advantage of the cleanness of the newly delivered SC1 sufficiently. The surfaces of the wafers are extremely hydrophilic, and hence the surfaces are not dried at the time of the substitution. Note that reference numeral 42 denotes a drying treatment region.

When the addition concentration of EDTPO needs to be further increased, the removal ability of silicon carbide grains in the column reduces, and hence this experiment machine was provided with a second adsorbent-packed column (hereinafter referred to as “second column”) 27, which is the same type as the first column, next to the first column so that double adsorption purification was able to be performed. That is, a treatment liquid to be purified is purified in the first column 27, the purified liquid is then returned into the storage container 24 via the valve 28 and a valve 31 through a purified liquid-returning pipe 32, the purified liquid is again sent as a treatment liquid to be purified via a valve 33 to the second column 27 for purification, yielding a double-purified liquid, the double-purified liquid is sent to the storage container 29 via an attached filter F, and the liquid is used for double-purified liquid cleaning.

When the initial cleaning of the first and second columns 27 and the regeneration cleaning of silicon carbide crystal faces serving as Fe adsorption surfaces are performed, a 2-wt % hydrogen peroxide/1 wt % hydrofluoric acid aqueous solution 26 contained in a cleaning liquid container 34 is sent into the first column 27 preliminarily cleaned with ultrapure water via a valve 36 and the valve 26, and the used aqueous solution is discharged via the valves 28 and 31 through a pipe for discharging liquid and gas 38. After that, in the same manner as that for the column cleaning water described above, ultrapure water for rinse is sent to the first column 27 through a pipe for supplying ultrapure water for rinse 39 by a valve operation, followed by discharge through the pipe for discharging liquid 38. The subsequent drying in the first column 27 is performed by sending a nitrogen gas to the column through a nitrogen gas supply pipe 40 by a valve operation, followed by discharge through the pipe for discharging gas 38. A cleaning liquid for the second column 27 is sent to the second column 27 through a valve 37 and the valve 33, and the other operations are carried out in accordance with the operations related to the first column 27.

When the liquid circulation mechanism of this experiment machine is applied to an apparatus for actual production, if necessary, the number of the columns is increased and the columns are sequentially cleaned while the apparatus is in action. When a chelating agent is added in a small amount or is not added, two columns are simultaneously used and each column is cleaned alternately at a stage requiring cleaning while the other column is in action.

In order to examine the effects of the multistage purification using the first and second columns 27, a high-purity chemical was selected to prepare a 300 ppb-EDTPO-added SC1, the 300 ppb-EDTPO-added SC1 was stored in the storage container 24, and a ⁵⁹Fe stock solution was added so that a 300 ppb-EDTPO-added SC1 having an Fe concentration of about 10 ppt was prepared. After that, the SC1 liquid was sent to the first column 27 at a flow rate of 200 mL/minute and was returned to the container 24 via the returning pipe 32, and the circulation was performed for five minutes to pass the liquid. Next, the same treatment was performed through the second column 27. After that, the grain cleaning mechanism was used to clean the grains in the first and second columns 27, and then purification was again performed through both columns. Finally, a sample was collected from the liquid in the container 24 and its radioactivity concentration was measured. The remaining ratio of Fe after the purification was found to be 3%. The maximum attainable Fe concentration of the liquid is about 300 ppq, and Fe on a silicon substrate surface can be cleaned to the extent of an adsorption concentration of 1×10⁸ atoms/cm² on the basis of FIG. 6 and FIG. 5.

Two pieces of the ⁵⁹Fe-contaminated oxidized wafers each having a roughened surface which were described previously were cleaned in this experiment machine in accordance with the process described above. That is, the wafers were cleaned with SPM at 130° C. for ten minutes and were cleaned with 2%-DHF at room temperature for ten minutes. At this stage, the wafers had an Fe concentration of (1 to 2)×10⁸ atoms/cm². After that, the wafers were subjected to SC1 cleaning under a standard condition in the cleaning tank 24 which contained a 30 ppb-EDTPO-added SC1 purified through the silicon carbide adsorption purification mechanism so as to have an estimated Fe concentration of 300 ppq. As a measurement result of the radioactivity of the cleaned wafers, the Fe concentration of the oxidized wafers was 6×10⁸ atoms/cm², and hence the intended Fe cleanness was attained.

When an alkaline hydrogen peroxide cleaning liquid to which EDTPO is added at a concentration in the range of 10 to 300 ppb is subjected to purification with silicon carbide, the alkaline hydrogen peroxide cleaning liquid can be highly purified to the extent of an Fe concentration of the ppq order, and the purified liquid can be used to clean a silicon substrate surface contaminated with Fe to an order of 1×10⁸ atoms/cm². Even if 1,2-propylenediaminetetramethylene phosphonic acid (methyl-EDTPO), which is produced by substituting the ethylene group of EDTPO with a propylene group, is used in place of EDTPO, its actions and effects are not different from those of EDTPO.

### Example 7

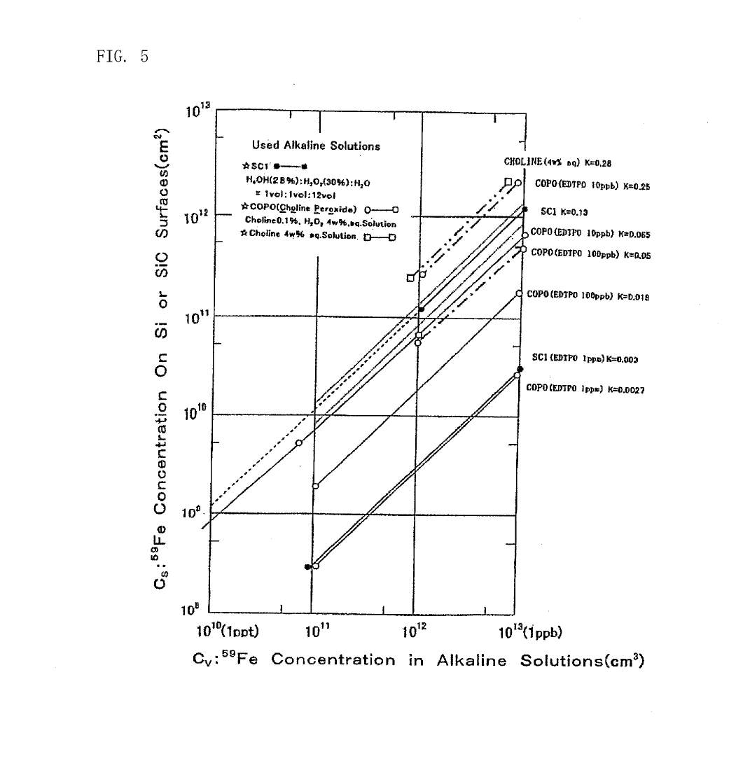

An adsorbing plate laminate (adsorption purification means) 1 in which a plurality of adsorbing plates 2 each having a silicon carbide crystal face were laminated, as illustrated in FIG. 4, was used instead of the first and second columns 27 packed with adsorbent grains used in Example 6. An alkaline treatment liquid is purified by being passed through the gaps between the adsorbing plates 2 in the adsorbing plate laminate 1.

The adsorbing plates 2 used in this Example 7 were produced by cutting a dummy wafer into pieces having predetermined dimensions through a laser process, the dummy wafer being manufactured by causing silicon carbide to grow additionally by CVD on a silicon carbide CVD substrate. The dummy wafer has a K value of nearly 0.4, and even if a 300 ppb-EDTPO-added SC1 liquid was used as an alkaline treatment liquid, a ⁵⁹Fe removal ratio of 75% or more was achieved, showing a good purification effect.

### REFERENCE SIGNS LIST

1: adsorbing plate laminate (adsorption purification means), 2: adsorbing plate, 3: holding cassette, 4: cassette ceiling portion, 5: cassette arm portion, 6: recessed portion for connecting to robot arm, 7: adsorbing plate-fixing groove, Lq: liquid to be purified, 10: treatment liquid purification apparatus, 11: liquid-to-be-purified purification region, 12: adsorbing-plate-laminate cleaning region, 13: adsorbing-plate-laminate drying region, 14: adsorption purification tank, 15: adsorbing-plate-laminate cleaning tank, 16: slope guide plane, 20: container for SPM treatment, 21: container for SC1 treatment, 22: container for rinse, 23: wafer to be cleaned, 24: storage container for liquid to be purified, 25: SC1 liquid, 26, 28, 31, 33, 36, 37: three-way valve, 27: first or second adsorbent-packed column, 29: storage container (provided with heating mechanism) for purified treatment liquid, 30: purified liquid in container, 31: valve, 32: purified liquid-returning pipe, 34: cleaning liquid container, 35: 2-wt % hydrogen peroxide/1-wt % hydrofluoric acid aqueous solution, 38: pipe for discharging liquid and gas, 39: pipe for supplying ultrapure water for rinse, 40: nitrogen gas supply pipe, 41: container for DHF treatment, 42: drying treatment region

1.-18. (canceled)

19. A method for purifying an alkaline treatment liquid for a semiconductor substrate, comprising:
bringing an alkaline treatment liquid free of alkali metals to be used for treating a semiconductor substrate, into contact with silicon carbide crystal faces in adsorption purification means; and
removing metal impurities contained in the alkaline treatment liquid through adsorption of the metal impurities to the silicon carbide crystal faces,
wherein each of the silicon carbide crystal faces is a (0001) crystal face of a silicon carbide single crystal, a (111) crystal face oriented on each crystal of a silicon carbide grain group formed by a chemical vapor deposition (CVD) method, or a crystal face of a silicon carbide polycrystal substrate formed by the CVD method.

20. A method for purifying an alkaline treatment liquid for a semiconductor substrate according to claim 19, wherein the alkaline treatment liquid is an ammonia aqueous solution or an organic strong base aqueous solution.

21. A method for purifying an alkaline treatment liquid for a semiconductor substrate according to claim 20, wherein an organic strong base in the organic strong base aqueous solution is a tetraalkylammonium hydroxide or a trimethylhydroxyalkyl-ammonium hydroxide.

22. A method for purifying an alkaline treatment liquid for a semiconductor substrate according to claim 21, wherein the tetraalkylammonium hydroxide comprises tetramethylammonium hydroxide (TMAH) and the trimethylhydroxyalkylammonium hydroxide comprises trimethylhydroxyethylammonium hydroxide (choline).

23. A method for purifying an alkaline treatment liquid for a semiconductor substrate according to any one of claims 20 to 22, wherein the alkaline treatment liquid comprises a hydrogen peroxide-containing alkaline cleaning liquid comprising hydrogen peroxide.

24. A method for purifying an alkaline treatment liquid for a semiconductor substrate according to claim 19, further comprising cleaning the silicon carbide crystal faces with an oxidant-containing dilute hydrofluoric acid cleaning liquid or a dilute oxidizing acid, yielding cleaned silicon carbide crystal faces, prior to the bringing of the alkaline treatment liquid into contact with the silicon carbide crystal faces in the adsorption purification means and the removing of the metal impurities contained in the alkaline treatment liquid through adsorption of the metal impurities to the silicon carbide crystal faces.

25. A method for purifying an alkaline treatment liquid for a semiconductor substrate according to claim 19, wherein the adsorption purification means is provided with treatment liquid circulation means to be used for recovering a used alkaline treatment liquid obtained after treating a semiconductor substrate in substrate treatment means for treating a semiconductor substrate, supplying the used alkaline treatment liquid recovered into the adsorption purification means, purifying and regenerating the used alkaline treatment liquid in the adsorption purification means, thereby yielding a regenerated alkaline treatment liquid, and supplying the regenerated alkaline treatment liquid again into the substrate treatment means.

26. A method for purifying an alkaline treatment liquid for a semiconductor substrate according to claim 25, wherein the alkaline treatment liquid contains from 10 to 300 ppb of any one of an ethylenediaminetetramethylenephosphonic acid (EDTPO) chelating agent or a 1,2-propylenediaminetetramethylenephosphonic acid (methyl-EDTPO) chelating agent in which an ethylene group of the ethylenediaminetetramethylenephosphonic acid (EDTPO) chelating agent is substituted with a propylene group.

27. A method for purifying an alkaline treatment liquid for a semiconductor substrate according to claim 19, wherein the semiconductor substrate comprises a substrate for a silicon device.

28. A method for purifying an alkaline treatment liquid for a semiconductor substrate according to claim 19, wherein the adsorption purification means having the silicon carbide crystal faces comprises an adsorbing plate laminate which is formed by laminating a plurality of thin plate-like adsorbing plates having silicon carbide crystal faces as surfaces thereof so that the silicon carbide crystal faces face each other with a predetermined distance between the crystal faces, and the alkaline treatment liquid is retained in or allowed to pass through a gap between the adsorbing plates in the adsorbing plate laminate, thereby bringing the alkaline treatment liquid into contact with the silicon carbide crystal faces.

29. A method for purifying an alkaline treatment liquid for a semiconductor substrate according to claim 19, wherein the adsorption purification means having the silicon carbide crystal faces comprises an adsorbent-packed column which is packed with grains of an adsorbent having [a] silicon carbide crystal faces as a surface thereof with a predetermined distance between the grains, and the alkaline treatment liquid is allowed to pass through the adsorbent-packed column, thereby bringing the alkaline treatment liquid into contact with the silicon carbide crystal faces.

30. A purification apparatus for an alkaline treatment liquid for a semiconductor substrate, which is used for purifying an alkaline treatment liquid free of alkali metals to be used for treating a semiconductor substrate, thereby removing metal impurities in the alkaline treatment liquid, comprising
adsorption purification means that has silicon carbide crystal faces with which the alkaline treatment liquid is brought into contact, and that is configured to remove metal impurities contained in the alkaline treatment liquid through adsorption of the metal impurities to the silicon carbide crystal faces,
wherein each of the silicon carbide crystal faces is a (0001) crystal face of a silicon carbide single crystal, a (111) crystal face oriented on each crystal of a silicon carbide grain group formed by a chemical vapor deposition (CVD) method, or a crystal face of a silicon carbide polycrystal substrate formed by the CVD method.

31. A purification apparatus for an alkaline treatment liquid for a semiconductor substrate according to claim 30, wherein the adsorption purification means having the silicon carbide crystal faces comprises an adsorbing plate laminate which is formed by laminating a plurality of thin plate-like adsorbing plates having silicon carbide crystal faces as surfaces thereof so that the silicon carbide crystal faces face each other with a predetermined distance between the crystal faces.

32. A purification apparatus for an alkaline treatment liquid for a semiconductor substrate according to claim 30, wherein the adsorption purification means having the silicon carbide crystal faces comprises an adsorbent-packed column which is packed with grains of an adsorbent having [a] silicon carbide crystal faces as a surface thereof with a predetermined distance between the grains.

33. A purification apparatus for an alkaline treatment liquid for a semiconductor substrate according to any one of claims 30 to 32, wherein the adsorption purification means having the silicon carbide crystal faces has a ratio (S/V) of a total area (S) of the silicon carbide crystal faces to a total volume (V) of the alkaline treatment liquid existing between the silicon carbide crystal faces of 10 to 130.

34. A purification apparatus for an alkaline treatment liquid for a semiconductor substrate according to claim 30, wherein the adsorption purification means is provided with treatment liquid circulation means to be used for recovering a used alkaline treatment liquid obtained after treating a semiconductor substrate in substrate treatment means for treating a semiconductor substrate, supplying the used alkaline treatment liquid recovered into the adsorption purification means, purifying the used alkaline treatment liquid in the adsorption purification means, thereby yielding a regenerated alkaline treatment liquid, and supplying the regenerated alkaline treatment liquid again into the substrate treatment means.

35. A purification apparatus for an alkaline treatment liquid for a semiconductor substrate according to claim 34, wherein the treatment liquid circulation means is provided with cleaning means for silicon carbide crystal faces configured to, when adsorption purification performance of the silicon carbide crystal faces in the adsorption purification means deteriorates, bring the silicon carbide crystal faces into contact with an oxidant-containing dilute hydrofluoric acid cleaning liquid or an dilute oxidizing acid, thereby cleaning the silicon carbide crystal faces.
